(19) United States
(12) Patent Application Publication
(10) Pub. No.: US 2012/0053742 A1
(43) Pub. Date: Mar. 1, 2012

(54) INFORMATION PROCESSING APPARATUS, INFORMATION PROCESSING METHOD, INFORMATION PROCESSING SYSTEM, AND TRANSPORTATION MEANS

(75) Inventor: Shinichiro Tsuda, Kanagawa (JP)

(73) Assignee: Sony Corporation, Tokyo (JP)

(21) Appl. No.: 13/215,442

(22) Filed: Aug. 23, 2011

(30) Foreign Application Priority Data
Aug. 30, 2010 (JP) 2010-192251

(51) Int. Cl. G06F 1/28; H02J 7/00

(52) U.S. Cl. 700/291; 320/134

(57) ABSTRACT

There is provided a power transmission/distribution network-control device including a communication section configured to receive a predetermined state quantity of a first storage battery from a first power source control device connected to the first storage battery, and a control section configured to control a first switch, the first switch being for establishing a connection, based on the predetermined state quantity of the first storage battery, between a first charging section which charges the first storage battery or a first linkage section which transmits power accumulated in the first storage battery to a distribution system, and the first storage battery.

### BACKGROUND

The present disclosure relates to an information processing apparatus, an information processing method, an information processing system, and transportation means. In particular, the present disclosure relates to a method of managing a storage battery and an electric vehicle within power utilities, and to power source control, a power transmission/distribution network, and a system, which are capable of reducing CO₂ emissions.

Nowadays, discussions on Smart Grid are actively taking place particularly in North America. A common definition of the Smart Grid is a next-generation power network which utilizes advanced IT technology and causes power demand and supply to dynamically follow each other, thereby realizing efficient use of power and the improvement in reliability thereof. In addition, an issue of global warming caused by CO₂ is also involved in the discussions, and the utilization of clean energy in the Smart Grid is also an important topic.

Demand for electricity varies greatly during the day (for example, refer to: The Federation of Electric Power Companies of Japan, “Information Plaza of Electricity, Graphical Flip-chart of Nuclear & Energy Related Topics 2010, Chapter 1, Energy Situation in Japan and the World”, online (searched on Aug. 11, 2010), Internet <URL: http://www.fepc.or.jp/library/publication/pamphlet/nuclear/zumenshu/index.html>). Since it is basically difficult to store electricity, the power supply that follows the greatly varying power demand has been realized by taking advantages of characteristics of various power sources and using a method of “Optimal Combination of Power Sources” for achieving total optimization. As for nuclear power generation, it is difficult to frequently switch between operation and stop operation. On the other hand, as for thermal power generation, it is flexible to frequently switch between operation and stop operation. Accordingly, the energy supplied by the nuclear power generation is used as a base of the power supply and the energy supplied by thermal power generation is used as a power source to be supplied in order to follow the change in the power demand, and this is the technique of “Optimal Combination of Power Sources” shown in The Federation of Electric Power Companies of Japan, “Information Plaza of Electricity, Graphical Flip-chart of Nuclear & Energy Related Topics 2010, Chapter 1, Energy Situation in Japan and the World”, online (searched on Aug. 11, 2010), Internet <URL: http://www.fepc.or.jp/library/publication/pamphlet/nuclear/zumenshu/index.html>.

### SUMMARY

In “Optimal Combination of Power Sources”, there is an issue that, although it is flexible to switch between operation and stop operation in the thermal power generation, the thermal power generation emits more CO₂ per kWh compared to other power generation methods. When attempting to reduce CO₂ emissions for the sake of environmental issues in the future, it is considered that the ratio of the nuclear energy used as the base energy has to be increased. What becomes an issue here is nighttime surplus power. The nighttime surplus power is currently utilized in pumped-storage power generation and the like, thereby dealing with the issue. However, in the case where the ratio of the nuclear energy used as the base energy is increased than at present, it may become difficult to deal with the issue only by utilizing the nighttime surplus power in the pumped-storage power generation.

Consequently, a storage battery in the Smart Grid and an electric vehicle (EV) are attracting attention. The fixed storage battery and the storage battery of the electric vehicle or the like are charged with the nighttime surplus power, and during the daytime period when the power demand is high, the power stored in the storage battery is used in combination with the energy supplied by the thermal power generation. Accordingly, the ratio of the energy supplied by the thermal power generation in “Optimal Combination of Power Sources” can be decreased than at present, and there can be expected CO₂ emission-reduction effect. For example, it is said that the total amount of annual thermal power generation in Japan is about 600 billion kWh. When converted into kWh per day, it is about 1.6 billion kWh.

On the other hand, a battery for an electric vehicle is being developed actively, and there appears a battery module having total power of 16 kWh. There are currently about 58 million passenger cars in Japan, and if we assume that all the passenger cars are replaced by electric vehicles, there is a battery with a capacity of about 900 million kWh. That is, even when estimated based on the current battery technology, the capacity corresponds to more than a half of the total amount of thermal power generation per day. Further improvement in the battery for an electric vehicle can be expected, and, by efficiently utilizing the battery for an electric vehicle for storing the nighttime surplus power, it can be expected to lead to significant reduction in CO₂ emission.

Next, as for operational efficiency of the storage battery, it is considered to be the optimum operation that there is a storage battery having a sufficient capacity to be charged with the nighttime surplus power without wasting it, and the power stored in the storage battery during nighttime is used up without being wasted during the daytime period when the power demand is high, that is, an operation of one cycle per day is considered to be the optimum. If the power remains in the battery after a cycle of one day, the remaining power is accumulated day by day, the capacity available for charging during nighttime decreases, and hence, the nighttime surplus power increases.

Further, there is a concern over an issue on a linkage with a distribution system, accompanied with the fact that the storage battery being a distributed power source, just as the case of the energy supplied by solar power generation and energy supplied by wind power generation. In the past, in the power system, the direction of flow of electricity was one-way, from a large-scale power plant to a household. However, owing to the spread of the solar power generation, the following phenomenon is beginning to occur: a reverse power flow, which means that the electricity flows in the reverse way from that of the past, in the form of selling electric power that is too much for household power consumption. As for the fixed storage battery, it will be possible to make an arrangement such that the chances of the reverse power flow becoming an issue is minimized, taking the distribution system into consideration. However, since the storage battery on an electric vehicle has mobility, and the used amount thereof during daytime is also different for each individual, it is considered that the following becomes important: the distribution system performs the concentrated management of the remaining power and the positions of the storage battery.

In light of the foregoing, it is desirable to provide a novel and improved technology capable of reducing CO₂ emissions from a power plant, and also capable of efficiently utilizing the power generated by the power plant.

According to an embodiment of the present disclosure, there is provided an information processing apparatus which includes a communication section configured to receive a predetermined state quantity of a first storage battery from a first power source control device connected to the first storage battery, and a control section configured to control a first switch, the first switch being for establishing a connection, based on the predetermined state quantity of the first storage battery, between a first charging section which charges the first storage battery or a first linkage section which transmits power accumulated in the first storage battery to a distribution system, and the first storage battery.

The communication section may further receive a predetermined state quantity of a second storage battery mounted on first transportation means from a second power source control device connected to the second storage battery. The control section may control a second switch, the second switch being for establishing a connection, based on the predetermined state quantity of the second storage battery, between a second charging section which charges the second storage battery or a second linkage section which transmits power accumulated in the second storage battery to a distribution system, and the second storage battery.

The information processing apparatus may further include a data storage section in a case where there are one or a plurality of the first storage batteries and one or a plurality of the second storage batteries, the data storage section being for storing information on power demand for each of geographically divided areas, and also stores charging capacity of the one or plurality of first storage batteries for each of the areas and charging capacity of the one or plurality of second storage batteries for each of the areas. The control section may calculate a sum total of charging capacity of the one or plurality of first storage batteries and the charging capacity of the one or plurality of second storage batteries for each of the areas, and may control the first switch and the second switch based on the calculated sum total for each of the areas and the information on power demand stored in the data storage section.

The communication section may receive, as the predetermined state quantity of the second storage battery, a remaining charge level value representing an amount of power stored in the second storage battery, and may further receive position information of the second storage battery from the first transportation means as history information. The control section may calculate an estimated consumption amount representing an amount of power of the second storage battery that is estimated to be consumed by driving the first transportation means based on the history information received by the communication section, and, when an amount of power obtained by subtracting the estimated consumption amount from the remaining charge level value received by the communication section exceeds a first threshold, the control section may control the second switch such that the second linkage section and the second storage battery are connected to each other.

When the amount of power obtained by subtracting the estimated consumption amount from the remaining charge level value received by the communication section is less than a second threshold, the control section may control the second switch such that the second charging section and the second storage battery are connected to each other.

The communication section may further receive, in addition to the remaining charge level value, charge/discharge times of the second storage battery as the predetermined state quantity of the second storage battery. The control section may perform correction in accordance with the charge/discharge times of the second storage battery, with respect to the amount of power obtained by subtracting the estimated consumption amount from the remaining charge level value received by the communication section, and may compare the corrected amount of power with the threshold.

When the communication section further receives an expected travel distance from the first transportation means, the control section may use an amount of power corresponding to the expected travel distance received by the communication section instead of the estimated consumption amount.

When an expected travel distance is not received from first transportation means and an expected travel distance is received from second transportation means by the communication section, the control section may control a switch such that a second storage battery mounted on the second transportation means is connected to a second linkage section which transmits power accumulated in the second storage battery to a distribution system, instead of controlling the second switch such that the second storage battery mounted on the first transportation means and the second linkage section are connected to each other.

The control section may calculate a price of power accumulated in the second storage battery mounted on the second transportation means to be higher than a price of power accumulated in the second storage battery mounted on the first transportation means.

The information processing apparatus may further include a data storage section in a case where there are one or a plurality of the first storage batteries and one or a plurality of the second storage batteries, the data storage section being for storing information on power demand for each of geographically divided areas, and also stores charging capacity of the one or plurality of first storage batteries for each of the areas and charging capacity of the one or plurality of second storage batteries for each of the areas. The control section may determine a distribution amount of surplus power generated in the distribution system for each of the areas based on the information on power demand stored in the data storage section, may calculate a sum total of the charging capacity of the one or plurality of first storage batteries for each of the areas, may control, as for an area in which the distribution amount is larger than the sum total, the first switch such that the first charging section and the first storage battery are connected to each other, and, may control, as for an area in which the distribution amount is smaller than the sum total, the first switch such that the first charging section and the first storage battery are connected to each other, based on geographical distribution of the information on power demand within the area stored in the data storage section.

As for an area in which the distribution amount is larger than the sum total, the control section may control the first switch such that the first charging section and the first storage battery are connected to each other and may also calculate a difference between the sum total and the distribution amount for each of the areas as a redistribution value, and may control the second switch such that the second charging section and the second storage battery of the area are connected to each other based on the redistribution value.

The information processing apparatus may further include a data storage section configured to store an electric power selling history representing a history on electric power selling between areas. The control section may calculate, as for a first area which is an area that the distribution amount is larger than the sum total, a difference between the sum total and the distribution amount as a redistribution value, may calculate a part or all of the redistribution value as a trade-distribution amount to be traded to a second area which is different from the first area based on the electric power selling history stored in the data storage section, may control the second switch such that, based on a value obtained by subtracting the trade-distribution amount from the redistribution value, the second charging section and the second storage battery of the first area are connected to each other, and may control the second switch such that, based on the trade-distribution amount, the second charging section and the second storage battery of the second area are connected to each other.

The communication section may receive charge/discharge times of each of the one or plurality of first storage batteries as the predetermined state quantity of each of the one or plurality of first storage batteries. The control section may control the first switch such that, as for an area the distribution amount of which is smaller than the sum total, the first storage battery having smaller charge/discharge times is preferentially connected to the first charging section.

In a case where there are one or a plurality of the first storage batteries and one or a plurality of the second storage batteries, the communication section may receive a remaining charge level value of each of the one or plurality of first storage batteries as the predetermined state quantity of each of the one or plurality of first storage batteries, and may also receive a remaining charge level value of each of the one or plurality of second storage batteries as the predetermined state quantity of each of the one or plurality of second storage batteries. The control section may determine an amount of power generation in a thermal power plant, based on a sum total obtained by adding up a value obtained by subtracting an amount of power corresponding to the estimated consumption amount or the expected travel distance from a sum total of the remaining charge level values of the respective one or plurality of second storage batteries, and a sum total of the remaining charge level values of the respective one or plurality of first storage batteries.

According to another embodiment of the present disclosure, there is provided transportation means which mounts a storage battery thereon, and transmits, as history information, position information of the storage battery to an information processing apparatus. The information processing apparatus calculates an estimated consumption amount representing an amount of power of the storage battery that is estimated to be consumed by driving the transportation means based on the history information, and, when an amount of power obtained by subtracting the estimated consumption amount from a remaining charge level value of the storage battery exceeds a first threshold, the information processing apparatus controls a switch such that a linkage section which transmits power accumulated in the storage battery to a distribution system is connected to the storage battery.

According to the embodiments of the present disclosure described above, CO₂ emissions from a power plant can be reduced, and the power generated by the power plant can be efficiently utilized.

### BRIEF DESCRIPTION OF THE DRAWINGS

FIG. 1 is a diagram showing a configuration of a power transmission/distribution network system according to an embodiment of the present disclosure;

FIG. 2 is a diagram showing a functional configuration of a power transmission/distribution network-control device included in the power transmission/distribution network system according to the embodiment;

FIG. 3 is a table showing an example of data managed by a server contained in the power transmission/distribution network-control device included in the power transmission/distribution network system according to the embodiment;

FIG. 4 is a diagram showing a configuration of transportation means, such as an electric vehicle, included in the power transmission/distribution network system according to the embodiment;

FIG. 5 is an example of information on power demand for each geographically divided area which is managed by the server contained in the power transmission/distribution network-control device included in the power transmission/distribution network system according to the embodiment;

FIG. 6 shows an example of a method of managing, for each geographically divided area, a specific second ID allocated to a first power source control device and a specific second ID allocated to a second power source control device by the server contained in the power transmission/distribution network-control device included in the power transmission/distribution network system according to the embodiment;

FIG. 7 is an example of a history of position information of a second storage battery held by the server contained in the power transmission/distribution network-control device included in the power transmission/distribution network system according to the embodiment;

FIG. 8 is a table showing an example of an average of travel distances calculated by the server contained in the power transmission/distribution network-control device included in the power transmission/distribution network system according to the embodiment;

FIG. 9 is a diagram showing a flow of processing (control example 1 of connection processing with a linkage section) performed in the power transmission/distribution network system according to the embodiment;

FIG. 10 is a diagram showing a flow of processing (control example of connection processing with the linkage section and connection processing with the charging section) performed in the power transmission/distribution network system according to the embodiment;

FIG. 11 is a diagram showing a flow of processing (control example 2 of connection processing with the linkage section) performed in the power transmission/distribution network system according to the embodiment;

FIG. 12 is a diagram showing a flow of processing (control example 3 of connection processing with the linkage section) performed in the power transmission/distribution network system according to the embodiment;

FIG. 13 is a diagram showing a flow of processing (control example 3 of connection processing with the linkage section) performed in the power transmission/distribution network system according to the embodiment;

FIG. 14 is a diagram showing a flow of processing (control example 4 of connection processing with the linkage section) performed in the power transmission/distribution network system according to the embodiment;

FIG. 15 is a diagram showing a flow of processing (purchase unit price-determination processing) performed in the power transmission/distribution network system according to the embodiment;

FIG. 16 is a diagram showing a flow of processing (control example 1 of connection processing with the charging section) performed in the power transmission/distribution network system according to the embodiment;

FIG. 17 is a diagram showing a flow of processing (control example 2 of connection processing with the charging section) performed in the power transmission/distribution network system according to the embodiment; and

FIG. 18 is a diagram showing a flow of processing (thermal power generation capacity-determination processing) performed in the power transmission/distribution network system according to the embodiment.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Further, the “detailed description of the embodiments” will be described in the order shown below.

1. Outline of embodiment

2. Embodiment
2-1. Configuration of power transmission/distribution network system
2-2. Functional configuration of power transmission/distribution network-control device
2-3. Example of data managed by server contained in power transmission/distribution network-control device
2-4. Configuration of transportation means such as electric vehicle included in power transmission/distribution network system
2-5. Example of information on power demand for each geographically divided area
2-6. Example of method of managing ID allocated to power source control device for each geographically divided area

2-7. Example of history of position information of second storage battery
2-8. Example of average of travel distance
2-9. Control example 1 of connection processing with linkage section
2-10. Control example of connection processing with linkage section and connection processing with charging section
2-11. Control example 2 of connection processing with linkage section
2-12. Control example 3 of connection processing with linkage section
2-13. Control example 4 of connection processing with linkage section
2-14. Purchase unit price-determination processing
2-15. Control example 1 of connection processing with charging section
2-16. Control example 2 of connection processing with charging section
2-17. Thermal power generation capacity-determination processing

3. Modified example

4. Effects

### 1. OUTLINE OF EMBODIMENT

There will be described an outline of an embodiment of the present disclosure. In order to enable an electric power company managing a distribution system to perform concentrated management of storage batteries, an ID for identifying an individual and information on maximum capacity are imparted to each of all the storage batteries (including a storage battery of an electric vehicle) to be charged with nighttime surplus power. The ID for identifying an individual and the information on maximum capacity are ultimately managed by an electric power company which manages the distribution system.

In addition, each storage battery is provided with a sensor which dynamically monitors a remaining battery level, a device for detecting position information (in general, a sensor using a GPS), a function of detecting the charge and discharge times (function of detecting a degradation state of the battery), and the like, and the remaining battery level, the position information, and the information on the degradation state of the battery are transmitted to the electric power company which manages the distribution system via wire or radio at a predetermined timing.

Further, as for the storage battery of an electric vehicle or the like, parking facilities for electric vehicles, such as a car park, is provided with a device to be linked with the distribution system, in order to use up the power other than the power used for a day's drive. Whether or not to switch on the device to be linked with the distribution system is determined by the electric power company which manages the distribution system. Here, criteria used for the determining whether not to switch on the device to be linked with the distribution system are power demand around the area, an expected travel distance until the next charging of the electric vehicle, and the like.

### 2. EMBODIMENT

### 2-1. Configuration of Power Transmission/Distribution Network System

Hereinafter, with reference to figures, an embodiment of the present disclosure will be described.

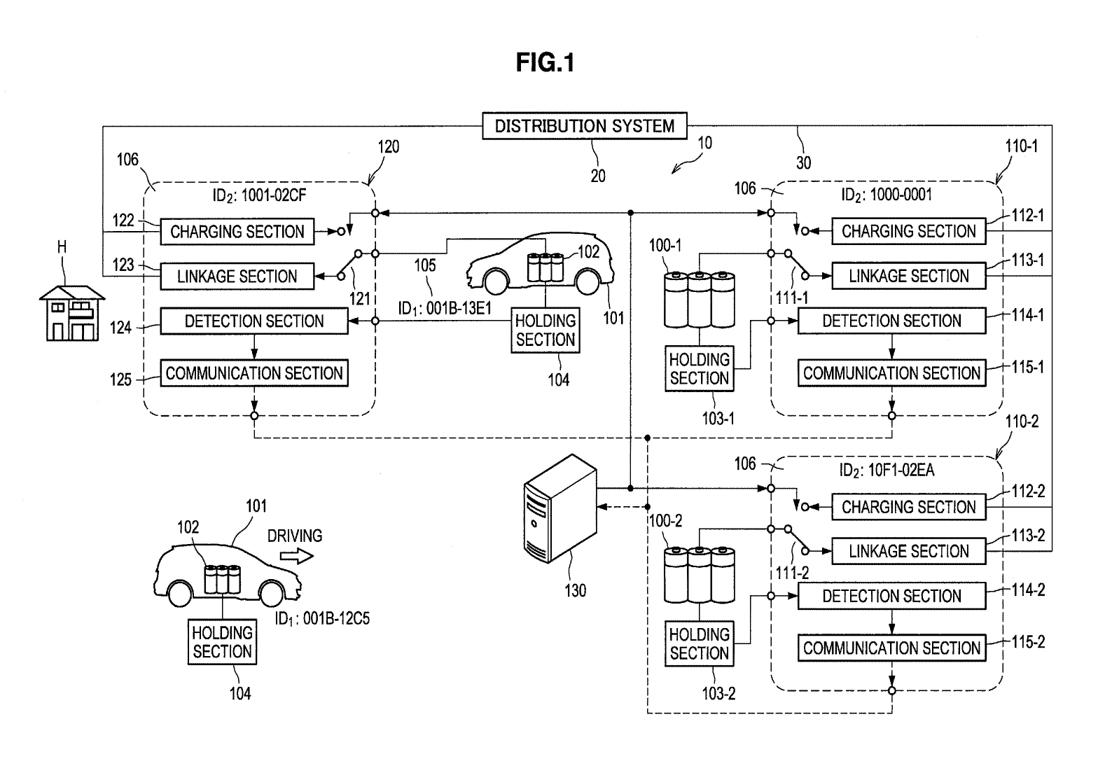

FIG. 1 is a diagram showing a configuration of a power transmission/distribution network system according to the embodiment of the present disclosure. A power transmission/distribution network system 10 according to the embodiment of the present disclosure is an example of an information processing system, and has a first storage battery 100-1, 100-2 provided in a fixed manner and a second storage battery 102 mounted on transportation means 101 such as an electric vehicle. Hereinafter, for example, in the case of showing a plurality of configurations each of which can be represented by a symbol X, the symbol to be attached to each configuration may be represented by, with a hyphen (-), X-1, X-2, . . . , or X-N. On the other hand, in the case where it is not particularly necessary to distinguish between the plurality of configurations, the symbol X will be used as the representative of the plurality of symbols X-1, X-2, . . . , and X-N. The first storage battery 100 has a first holding section 103, and the second storage battery 102 has a second holding section 104. The first holding section 103 holds a first remaining amount and first charge/discharge times, and the second holding section 104 holds a second remaining amount and second charge/discharge times.

The first power source control device 110 includes a first switch 111, a first charging section 112, a first linkage section 113, a first detection section 114, and a first communication section 115. The first storage battery 100 is connected to the first charging section 112 or the first linkage section 113 via the first switch 111. The first holding section 103 is connected to the first detection section 114, and the first remaining amount and the first charge/discharge times of the first storage battery 100 are transferred from the first holding section 103 to the first communication section 115 at a predetermined timing.

The second power source control device 120 includes a second switch 121, a second charging section 122, a second linkage section 123, a second detection section 124, and a second communication section 125. The second storage battery 102 is connected to the second charging section 122 or the second linkage section 123 via the second switch 121. The second holding section 104 is connected to the second detection section 124, and the second remaining amount, the second charge/discharge times, and a specific first ID of the second storage battery 102 are transferred from the second holding section 104 to the second communication section 125 at a predetermined timing.

Further, a specific first ID 105 is allocated to the second storage battery 102, and a specific second ID 106 is allocated to each of the first power source control device 110 and the second power source control device 120.

A power transmission/distribution network-control device 130, which functions as an example of an information processing apparatus, receives, via the first communication section 115, the first remaining amount and the first charge/discharge times of the first storage battery 100 and the specific second ID 106 allocated to the first power source control device 110. In addition, the power transmission/distribution network-control device 130 receives, via the second communication section 125, the second remaining amount, the second charge/discharge times, and the specific first ID 105 of the second storage battery 102, and also receives the specific second ID 106 allocated to the second power source control device 120.

In this case, authentication operation is appropriately performed between the power transmission/distribution network-control device 130 and the second storage battery 102 via the first ID 105, and authentication operation is appropriately performed, via the second ID 106, between the power transmission/distribution network-control device 130 and the first power source control device 110 and between the power transmission/distribution network-control device 130 and the second power source control device 120. In addition, the power transmission/distribution network-control device 130 independently controls the first switch 111 included in the first power source control device 110 and the second switch 121 included in the second power source control device 120.

The power transmission/distribution network system 10 has at least the first storage battery 100 provided in a fixed manner, the second storage battery 102 mounted on transportation means 101 such as an electric vehicle, the first power source control device 110, the second power source control device 120, and the power transmission/distribution network-control device 130. The number of the first storage batteries 100 and the number of the second storage batteries 102 are not particularly limited, and may each be one, or two or more. The first storage battery 100 and the second storage battery 102 each have sufficient capacity to be charged with nighttime surplus power.

The first storage battery 100 has the first holding section 103 which holds the first remaining amount and the first charge/discharge times, and the second storage battery 102 has the second holding section 104 which holds the second remaining amount and the second charge/discharge times. A specific first ID 105 is allocated to the second storage battery 102, and the authentication can be performed between the power transmission/distribution network-control device 130 and the second storage battery 102 via the first ID 105. To the first storage battery 100, the first power source control device 110 is connected, and the second storage battery 102 has an interface to be connected to the second power source control device 120.

A specific second ID 106 is allocated to each of the first power source control device 110 and the second power source control device 120, and the authentication can be performed via the second ID 106, between the power transmission/distribution network-control device 130 and the first power source control device 110 and between the power transmission/distribution network-control device 130 and the second power source control device 120.

The first storage battery 100 is connected to the first charging section 112 or the first linkage section 113 via the first switch 111. The first linkage section 113 has a DC/AC conversion function, and the first power source control device 110 has the first detection section 114 which reads out, while being connected to the first storage battery 100, the remaining charge level and the charge/discharge times of the first storage battery 100 at a predetermined timing. Further, the first power source control device 110 has the first communication section 115 for transmitting the remaining charge level and the charge/discharge times which are read out by the first detection section 114 to a server contained in the power transmission/distribution network-control device 130. The first communication section 115 is capable of performing communication via wire or radio. The first switch 111 included in the first power source control device 110 may be controlled by the server contained in the power transmission/distribution network-control device 130 such that the first storage battery 100 is connected to the first charging section 112, such that the first storage battery 100 is connected to the first linkage section 113, or such that the first storage battery 100 is not connected to the first charging section 112 nor to the first linkage section 113. While the first switch 111 included in the first power source control device 110 is being connected to the first charging section 112, the first charging section 112 charges the first storage battery 100 via the first switch 111 from the distribution system (power transmission/distribution system) 20. Here, the first charging section 112 has an AC/DC conversion function which becomes necessary when the first storage battery 100 is charged with the power supplied by the distribution system 20-side. While the first switch 111 included in the first power source control device 110 is being connected to the first linkage section 113, the electricity accumulated in the first storage battery 100 is transmitted to the distribution system 20 via the first switch 111 by the first linkage section 113. Here, the first linkage section 113 has a DC/AC conversion function which becomes necessary for supplying the distribution system 20-side with the power accumulated in the first storage battery 100, and additionally has a function of controlling a voltage to be higher than the voltage value of the power system-side. Further, the first linkage section 113 may have a function of, using the server contained in the power transmission/distribution network-control device 130, advancing or delaying the phase of the current with respect to the phase of the voltage. The distribution system 20 builds a distribution network for transmitting electricity to a distribution destination such as the first storage battery 100 or the second storage battery 102. In this case, the electricity is transmitted to the distribution destination such as the first storage battery 100 or the second storage battery 102 via an electric wire 30 from the distribution system 20, for example. The electric wire 30 is, for example, formed of a conductor for conducting electricity. The electric wire 30 may be a power cable formed by covering a conductor with an insulator and a protective covering, for example.

The second storage battery 102 is connected to the second charging section 122 or the second linkage section 123 via the second switch 121. During the period where the transportation means 101 having the second storage battery 102 is being parked, the second power source control device 120 is connected to the second storage battery 102. The second linkage section 123 has a DC/AC conversion function, and the second power source control device 120 has the second detection section 124 which reads out, while being connected to the second storage battery 102, the first ID 105, the remaining charge level, and the charge/discharge times of the second storage battery 102 at a predetermined timing. Further, the second power source control device 120 has the second communication section 125 for transmitting the first ID 105, the remaining charge level, and the charge/discharge times which are read out by the second detection section 124 to a server contained in the power transmission/distribution network-control device 130. The second communication section 125 is capable of performing communication via wire or radio. The second switch 121 included in the second power source control device 120 may be controlled by the server contained in the power transmission/distribution network-control device 130 such that the second storage battery 102 is connected to the second charging section 122, such that the second storage battery 102 is connected to the second linkage section 123, or such that the second storage battery 102 is not connected to the second charging section 122 nor to the second linkage section 123. While the second switch 121 included in the second power source control device 120 is being connected to the second charging section 122, the second charging section 122 charges the second storage battery 102 via the second switch 121 from the distribution system 20. Here, the second charging section 122 has an AC/DC conversion function which becomes necessary when the second storage battery 102 is charged with the power supplied by the distribution system 20-side. While the second switch 121 included in the second power source control device 120 is being connected to the second linkage section 123, the electricity accumulated in the second storage battery 102 is transmitted to the distribution system 20 via the second switch 121 by the second linkage section 123. Here, the second linkage section 123 has a DC/AC conversion function which becomes necessary for supplying the distribution system 20-side with the power accumulated in the second storage battery 102, and additionally has a function of controlling a voltage to be higher than the voltage value of the power system-side. Further, the second linkage section 123 may have a function of, using the server contained in the power transmission/distribution network-control device 130, advancing or delaying the phase of the current with respect to the phase of the voltage.

The server contained in the power transmission/distribution network-control device 130 has a function of managing position information, a maximum capacity value, and dynamic remaining charge level value and charge/discharge times, by linking the above with a specific first ID 105 allocated to the second storage battery 102 with a specific second ID 106 allocated to the first power source control device 110. The power transmission/distribution network-control device 130 controls the first switch 111 included in the first power source control device 110 and the second switch 121 included in the second power source control device 120 by communication via wire or radio.

According to such a configuration, the fixed storage battery and the storage battery mounted on an electric vehicle, which is considered to be widespread in the days to come, are charged with the nighttime surplus power, and during the daytime period when the power demand is high, the power stored in those storage batteries is used. This enables the operation in which the energy supplied by the nuclear power generation, which is used as a base in “Optimal Combination of Power Sources”, is increased, and there can be expected CO₂ emission-reduction effect. Further, since the remaining amount and the charge and discharge times of each of those storage batteries can be dynamically managed for each specific ID at the power transmission/distribution system-side, there can be executed more flexible operation.

### 2-2. Functional Configuration of Power Transmission/Distribution Network-Control Device

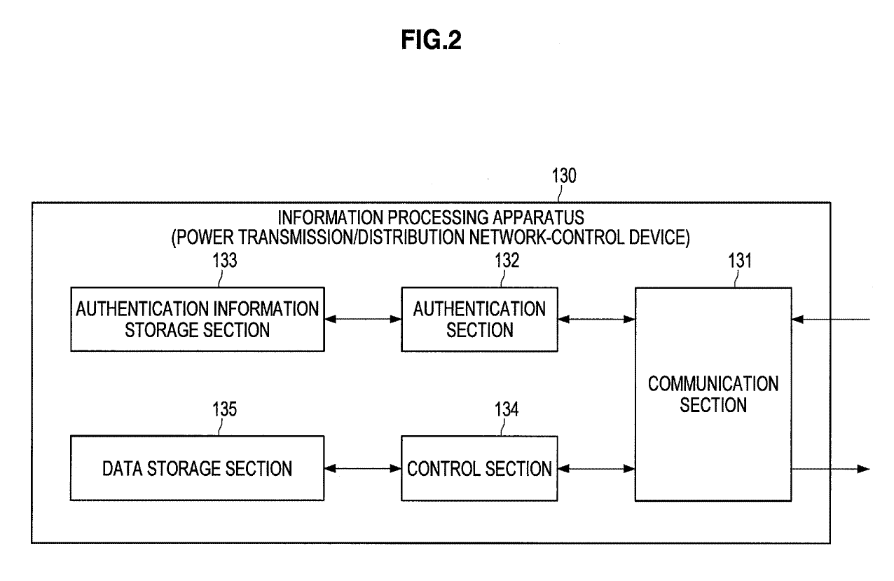

FIG. 2 is a diagram showing a functional configuration of the power transmission/distribution network-control device 130 included in the power transmission/distribution network system 10 according to the embodiment of the present disclosure. Each functional block shown in FIG. 2 is included in the server contained in the power transmission/distribution network-control device 130. The power transmission/distribution network-control device 130 includes at least a communication section 131 and a control section 134. The power transmission/distribution network-control device 130 may include an authentication section 132 and an authentication information storage section 133. The authentication section 132 performs authentication between the power transmission/distribution network-control device 130 and the first power source control device 110 and between the power transmission/distribution network-control device 130 and the second power source control device 120, and the authentication information storage section 133 stores information necessary for the authentication.

The communication section 131 has a function of receiving a predetermined state quantity of the first storage battery 100 from the first power source control device 110 connected to the first storage battery 100. It is assumed that examples of the predetermined state quantity include the first remaining amount and the first charge/discharge times of the first storage battery 100, but the examples are not limited thereto. In FIG. 1, although there are shown two first storage batteries 100, the number of the first storage batteries 100 is not particularly limited, and may be one, or two or more.

The control section 134 has a function of controlling the first switch 111, the first switch 111 being used for establishing a connection, based on the predetermined state quantity of the first storage battery 100, between: the first charging section 112 which charges the first storage battery 100 or the first linkage section 113 which transmits the power accumulated in the first storage battery 100 to the distribution system 20; and the first storage battery 100.

In the same manner, the communication section 131 may further receive a predetermined state quantity of the second storage battery 102 mounted on first transportation means 101 from the second power source control device 120 connected to the second storage battery 102, and the control section 134 may control the second switch 121, the second switch 121 being used for establishing a connection, based on the predetermined state quantity of the second storage battery 102, between: the second charging section 122 which charges the second storage battery 102 or the second linkage section 123 which transmits the power accumulated in the second storage battery 102 to the distribution system 20; and the second storage battery 102. In FIG. 1, although there are shown two second storage batteries 102, the number of the second storage batteries 102 is also not particularly limited, and may be one, or two or more.

The power transmission/distribution network-control device 130 is also capable of controlling the first switch 111 and the second switch 121 by taking into consideration the information on power demand for each geographically divided area, for example. That is, in the case where there are one or more first storage batteries 100 and one or more second storage batteries 102, the power transmission/distribution network-control device 130 may include a data storage section 135 which stores information on power demand for each area. The data storage section 135 further stores charging capacity of one or more first storage batteries 100 for each area, and further stores charging capacity of one or more second storage batteries 102 for each area.

The charging capacity of the first storage battery 100 is an amount of power which the first storage battery 100 can be charged with, and represents a maximum capacity, for example. The area of the first storage battery 100 represents, for example, an area where the first power source control device 110 connected to the first storage battery 100 is located, and the area of the second storage battery 102 represents, for example, an area where the second power source control device 120 connected to the second storage battery 102 is located.

In that case, the control section 134 calculates a sum total of the charging capacity of one or more first storage batteries 100 and the charging capacity of one or more second storage batteries 102 for each area, and may control the first switch 111 and the second switch 121 based on the calculated sum total for each area and on the information on power demand stored in the data storage section 135.

Further, the power transmission/distribution network-control device 130 is also capable of controlling the first switch 111 and the second switch 121 by taking into consideration the power consumed by the transportation means 101. That is, the communication section 131 receives, as the predetermined state quantity of the second storage battery 102, a remaining charge level value representing an amount of power in the second storage battery 102, and may further receive position information of the second storage battery 102 from the first transportation means 101 as history information.

In that case, the control section 134 calculates an estimated consumption amount representing an amount of power of the second storage battery 102 that is estimated to be consumed by driving the first transportation means 101 based on the history information received by the communication section 131, and, in the case where an amount of power obtained by subtracting the estimated consumption amount from the remaining charge level value received by the communication section 131 exceeds a first threshold, the control section 134 may control the second switch 121 such that the second linkage section 123 and the second storage battery 102 are connected to each other.

In the case where the estimated consumption amount is large, the power transmission/distribution network-control device 130 is also capable of controlling the second switch 121 such that the second charging section 122 and the second storage battery 102 are connected to each other. That is, in the case where the amount of power obtained by subtracting the estimated consumption amount from the remaining charge level value received by the communication section 131 is less than a second threshold, the control section 134 may control the second switch 121 such that the second charging section 122 and the second storage battery 102 are connected to each other.

The power transmission/distribution network-control device 130 is also capable of performing correction in accordance with the charge/discharge times of the second storage battery 102. That is, the communication section 131 further receives, in addition to the remaining charge level value, the charge/discharge times of the second storage battery 102 as the predetermined state quantity of the second storage battery 102, and the control section 134 may perform correction in accordance with the charge/discharge times of the second storage battery 102, with respect to the amount of power obtained by subtracting the estimated consumption amount from the remaining charge level value received by the communication section 131, and may compare the corrected amount of power with a threshold. The charge/discharge times may be a total of the charge times and the discharge times, or may be one of the charge times and the discharge times.

For the transportation means 101 which performs notification of an expected travel distance, the power transmission/distribution network-control device 130 is also capable of using the expected travel distance in preference to the estimated consumption amount. That is, the in the case where the communication section 131 further receives the expected travel distance from the first transportation means 101, the control section 134 may use the amount of power corresponding to the expected travel distance received by the communication section 131 instead of the estimated consumption amount. That is, the control section 134 may determine whether or not an amount of power, which is obtained by subtracting the amount of power corresponding to the expected travel distance from the remaining charge level value received by the communication section 131, exceeds the first threshold. Further, the control section 134 may also determine whether or not the amount of power, which is obtained by subtracting the amount of power corresponding to the expected travel distance from the remaining charge level value received by the communication section 131, is less than the second threshold.

For transportation means 101 which performs notification of the expected travel distance, the power transmission/distribution network-control device 130 is also capable of controlling the power accumulated in the second storage battery 102 mounted on the transportation means 101 to be preferentially transmitted to the distribution system 20. That is, in the case where an expected travel distance is not received from first transportation means 101 and an expected travel distance is received from second transportation means 101 by the communication section 131, the control section 134 may control the second switch 121 such that the second storage battery 102 mounted on the second transportation means 101 is connected to the second linkage section 123 which transmits the power accumulated in the second storage battery 102 to the distribution system 20, instead of controlling the second switch 121 such that the second storage battery 102 mounted on the first transportation means 101 and the second linkage section 123 are connected to each other.

The power transmission/distribution network-control device 130 is also capable of setting a relatively high price for an electric power selling price of the power accumulated in the second storage battery 102 mounted on transportation means 101 which performs notification of the expected travel distance. That is, the control section 134 may calculate a price of the power accumulated in the second storage battery 102 mounted on the second transportation means 101 to be higher than a price of the power accumulated in the second storage battery 102 mounted on the first transportation means 101.

The power transmission/distribution network-control device 130 is also capable of controlling surplus power generated in the distribution system 20 to be distributed to the first storage battery 100 and the second storage battery 102. In the case where there are one or more first storage batteries 100 and one or more second storage batteries 102, the power transmission/distribution network-control device 130 may include the data storage section 135 which stores information on power demand for each area. The data storage section 135 further stores charging capacity of one or more first storage batteries 100 for each area, and further stores charging capacity of one or more second storage batteries 102 for each area.

In that case, the control section 134 determines a distribution amount of the surplus power generated in the distribution system 20 for each area based on the information on power demand stored in the data storage section 135, and also calculates a sum total of the charging capacity of one or more first storage batteries 100 for each area. Then, as for an area in which the distribution amount is larger than the sum total, the control section 134 may control the first switch 111 such that the first charging section 112 and the first storage battery 100 are connected to each other. Since a distribution amount is enough for charging all the first storage batteries 100 within the area, all the first storage batteries 100 within the area can be charged. Further, as for an area in which the distribution amount is smaller than the sum total, the control section 134 may control the first switch 111 such that the first charging section 112 and the first storage battery 100 are connected to each other, based on geographical distribution of the information on power demand within the area stored in the data storage section 135. This is because there is a first storage battery 100 which cannot be charged within the area, and it is necessary to determine which first storage battery 100 is controlled to be charged. For example, the control section 134 may control the first storage battery 100 to be charged, which is located near a place (household or the like) with large power demand based on geographical distribution (indicating degree of power demand for each place within the area) of information on power demand within the area. In this way, for example, transmission loss which occurs when transmitting electricity from the first storage battery 100 to a household with large power demand can be reduced.

The power transmission/distribution network-control device 130 is also capable of controlling the surplus power which has not been distributed to be used for the charging of the second storage battery 102 mounted on the transportation means 101. That is, as for an area in which the distribution amount is larger than the sum total, the control section 134 controls the first switch 111 such that the first charging section 112 and the first storage battery 100 are connected to each other, and also calculates a difference between the sum total and the distribution amount for each area as a redistribution value. Then, the control section 134 may control the second switch 121 such that the second charging section 122 and the second storage battery 102 of the area are connected to each other based on the redistribution value. That is, the control section 134 may control the second switch 121 such that the power corresponding to the redistribution value is supplied to the second storage battery 102 of the area.

The power transmission/distribution network-control device 130 is also capable of controlling the power equivalent to the redistribution value to be traded between areas based on an electric power selling history. That is, the power transmission/distribution network-control device 130 may further include the data storage section 135 which stores the electric power selling history representing a history on the electric power selling between areas.

In that case, the control section 134 may calculate, as for a first area which is an area that the distribution amount is larger than the sum total, a difference between the sum total and the distribution amount as a redistribution value. Then, the control section 134 calculates a part or all of the redistribution value as a trade-distribution amount to be traded to a second area which is different from the first area, based on the electric power selling history stored in the data storage section 135. The control section 134 may control the second switch 121 such that, based on a value obtained by subtracting the trade-distribution amount from the redistribution value, the second charging section 122 and the second storage battery 102 of the first area are connected to each other, and may also control the second switch 121 such that, based on the trade-distribution amount, the second charging section 122 and the second storage battery 102 of the second area are connected to each other.

The power transmission/distribution network-control device 130 is also capable of controlling in a manner to preferentially charge a first storage battery 100 the charge/discharge times of which is small. That is, the communication section 131 receives the charge/discharge times of each of one or more first storage batteries 100 as the predetermined state quantity of each of one or more first storage batteries 100. In that case, the control section 134 may control the first switch 111 such that, as for an area the distribution amount of which is smaller than the sum total, a first storage battery 100 having smaller charge/discharge times is preferentially connected to the first charging section 112.

The power transmission/distribution network-control device 130 is also capable of determining an amount of power to be generated in a thermal power plant. That is, in the case where there are one or more first storage batteries 100 and one or more second storage batteries 102, the communication section 131 receives a remaining charge level value of each of the one or more first storage batteries 100 as the predetermined state quantity of each of the one or more first storage batteries 100, and also receives a remaining charge level value of each of the one or more second storage batteries 102 as the predetermined state quantity of each of the one or more second storage batteries 102.

In that case, the control section 134 may determine an amount of power generation in the thermal power plant, based on a sum total obtained by adding up: a value obtained by subtracting an amount of power corresponding to the estimated consumption amount or the expected travel distance from a sum total of the remaining charge level values of the respective one or more second storage batteries 102; and a sum total of the remaining charge level values of the respective one or more first storage batteries 100.

The transportation means 101 mounts the second storage battery 102 thereon, and is capable of transmitting, as history information, position information of the second storage battery 102 to the power transmission/distribution network-control device 130. The control section 134 of the power transmission/distribution network-control device 130 can, as described above, calculate the estimated consumption amount representing an amount of power of the second storage battery 102 that is estimated to be consumed by driving the transportation means 101 based on the history information. Further, in the case where the amount of power obtained by subtracting the estimated consumption amount from a remaining charge level value of the second storage battery 102 exceeds a first threshold, the control section 134 can control the second switch 121 such that the second linkage section 123 which transmits the power accumulated in the second storage battery 102 to the distribution system 20 is connected to the second storage battery 102.

### 2-3. Example of Data Managed by Server Contained in Power Transmission/Distribution Network-Control Device

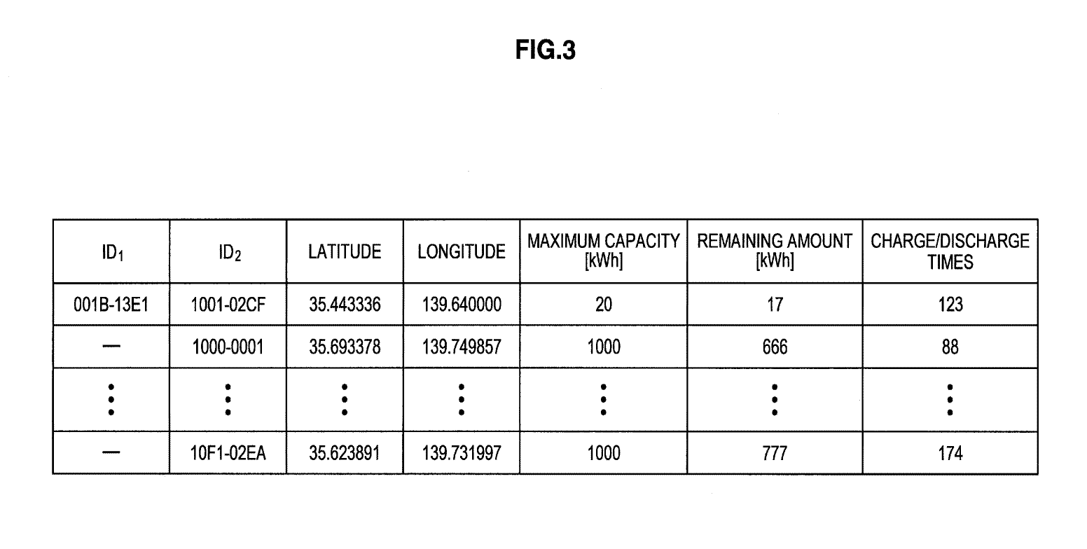

FIG. 3 is a table showing an example of data managed by a server contained in the power transmission/distribution network-control device 130 included in the power transmission/distribution network system 10 according to the embodiment of the present disclosure. The data is managed by the server by being stored in the data storage section 135, for example. A specific second ID allocated to the first power source control device 110, position information (latitude and longitude), and a maximum capacity of the first storage battery 100 are registered in advance. The server contained in the power transmission/distribution network-control device 130 receives a remaining charge level and charge/discharge times of the first storage battery 100 and the specific second ID 106 allocated to the first power source control device 110, which are transmitted from the first communication section 115, and updates the remaining charge level and the charge/discharge times of the first storage battery 100 written on a row corresponding to the second ID 106 with the received pieces of information.

Further, a specific second ID 106 allocated to the second power source control device 120, and position information are registered in advance. When any second storage battery 102 of the second power source control device 120 is connected to the second power source control device 120, the second communication section 125 transmits a remaining charge level, charge/discharge times, and a specific first ID 105 of the second storage battery 102, and the specific second ID 106 allocated to the second power source control device 120 to the server contained in the power transmission/distribution network-control device 130. The server contained in the power transmission/distribution network-control device 130 updates the specific first ID 105, and the remaining charge level and the charge/discharge times of the second storage battery 102 written on a row corresponding to the received second ID 106 with the received pieces of information. In addition, using the specific first ID 105 as a reference, a maximum capacity of the second storage battery 102 is written in the table.

### 2-4. Configuration of Transportation means, such as Electric Vehicle, Included in Power Transmission/Distribution Network System

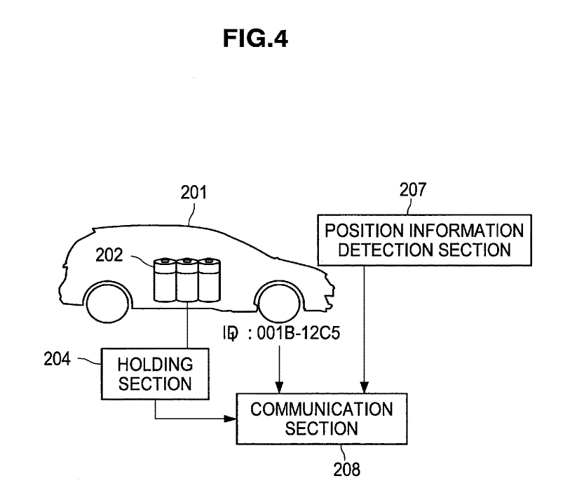

FIG. 4 is a diagram showing a configuration of transportation means 201, such as an electric vehicle, included in the power transmission/distribution network system 10 according to the embodiment of the present disclosure. The transportation means 201 such as an electric vehicle has a second storage battery 202, a holding section 204, a position information detection section 207, and a third communication section 208. The holding section 204 holds a second remaining amount and second charge/discharge times of the second storage battery 202. While the third communication section 208 is not connected to the second power source control device 120, such as while driving, the third communication section 208 transmits a remaining amount, charge/discharge times, a specific first ID 105, and position information of the second storage battery 202 to the server contained in the power transmission/distribution network-control device 130 at a predetermined timing. Note that it goes without saying that the position information detection section 207 may work in conjunction with an in-vehicle car navigation system.

In this way, the transportation means 201 such as an electric vehicle has the second storage battery 202, the holding section 204 holding the second remaining amount and the second charge/discharge times, the position information detection section 207, and the third communication section 208, and the third communication section 208 is capable of performing communication via wire or radio. The third communication section 208 transmits the specific first ID 105 allocated to the second storage battery 202, the remaining amount and the charge/discharge times of the second storage battery 202, and the position information indicating information on a position of the second storage battery 202 to the server contained in the power transmission/distribution network-control device 130.

According to such a configuration, it is possible to transmit during driving the remaining amount, the charge/discharge times, and the position information of the second storage battery 202 mounted on the transportation means 201 such as an electric vehicle, and hence becomes possible to dynamically grasp the situation of the second storage battery 202 during travelling at the side of controlling the power transmission/distribution system.

### 2-5. Example of Information on Power Demand for each Geographically Divided Area

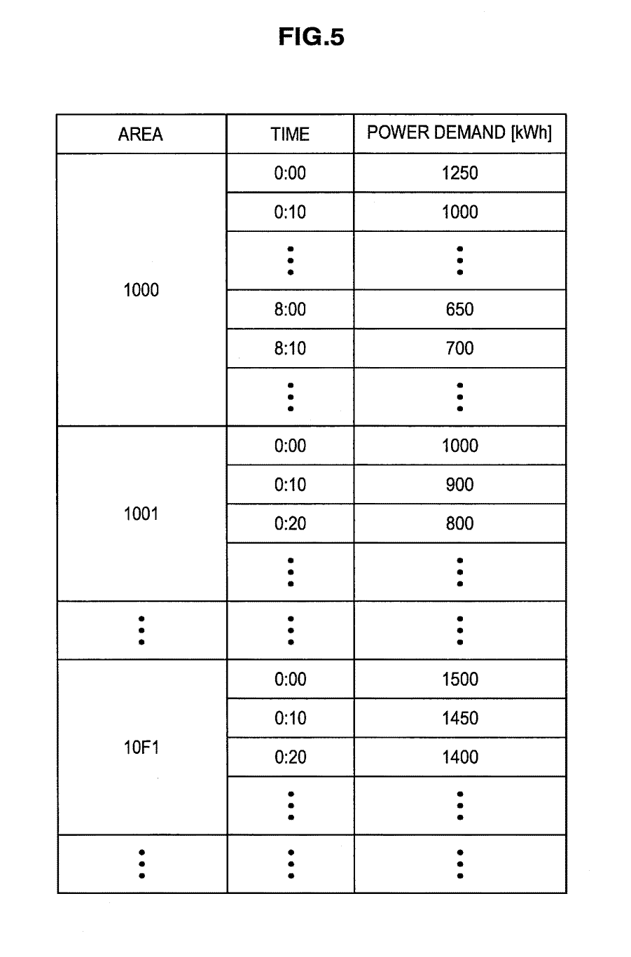

FIG. 5 is an example of information on power demand for each geographically divided area which is managed by the server contained in the power transmission/distribution network-control device 130 included in the power transmission/distribution network system 10 according to the embodiment of the present disclosure. The information is managed by the server by being stored in the data storage section 135, for example. The power demand for each area is managed at regular time intervals.

In this way, the server contained in the power transmission/distribution network-control device 130 has the information on power demand for each geographically divided area. The information on power demand is managed in the form of power demand at regular time intervals. The server contained in the power transmission/distribution network-control device 130 classifies a specific second ID 106 allocated to the first power source control device 110 and a specific second ID 106 allocated to the second power source control device 120 into groups for each area, and, in accordance with the size of the power demand for each area, controls for each area the first switch 111 included in the first power source control device 110 and the second switch 121 included in the second power source control device 120.

According to such a configuration, the server contained in the power transmission/distribution network-control device 130 can grasp the power demand for each area, and also becomes capable of dynamically managing the state of the storage battery for each area via the specific ID allocated to the storage battery. Accordingly, detailed utilization of the storage battery in accordance with the dynamic power demand for each area becomes possible.

### 2-6. Example of Method of Managing ID Allocated to Power Source Control Device for each Geographically Divided Area

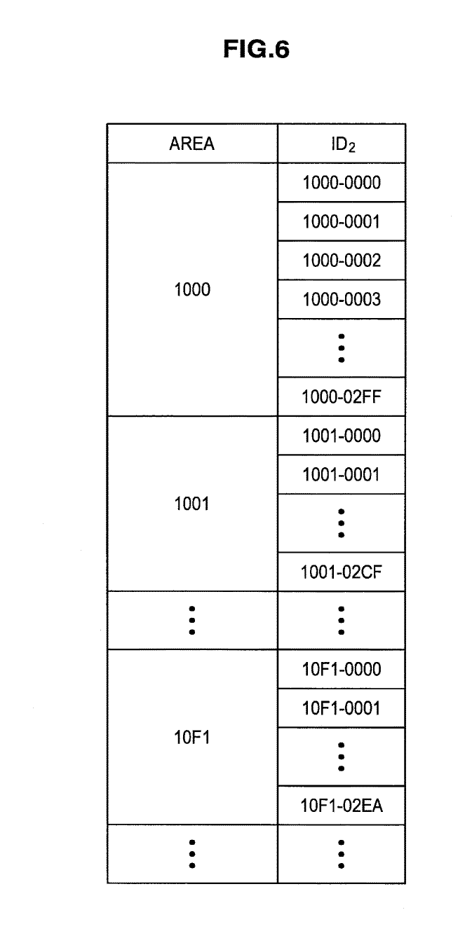

FIG. 6 shows an example of a method of managing, for each geographically divided area, a specific second ID 106 allocated to a first power source control device 110 and a specific second ID 106 allocated to a second power source control device 120 by the server contained in the power transmission/distribution network-control device 130 included in the power transmission/distribution network system 10 according to the embodiment of the present disclosure.

In the power transmission/distribution network system 10 according to the embodiment of the present disclosure, the control of the first switch 111 included in the first power source control device 110 and the control of the second switch 121 included in the second power source control device 120 are performed as follows. The server contained in the power transmission/distribution network-control device 130 calculates a sum total of power demand during the daytime period for each area based on the data shown in FIG. 5. Although the specific daytime time period is not particularly limited, it is a time period in which people work using electric power, for example, and may be freely set, such as from 6 a.m. to 10 p.m.

Next, the server contained in the power transmission/distribution network-control device 130 calculates a sum total of maximum capacity of the first storage battery 100 and the second storage battery 102 connected to the first power source control device 110 and the second power source control device 120 corresponding to the specific second ID's 106 managed for each area as shown in FIG. 6. Then, during the time period of the nighttime in which surplus power is generated in a range that does not exceed the sum total of power demand during daytime hours for each area, the server contained in the power transmission/distribution network-control device 130 controls the first switch 111 included in the first power source control device 110 such that the first storage battery 100 is connected to the first charging section 112, and controls the second switch 121 included in the second power source control device 120 such that the second storage battery 102 is connected to the second charging section 122. Although the specific nighttime period is not particularly limited, it may be set freely, and the nighttime period may be a time period which does not correspond to the daytime period, for example.

On the other hand, during the daytime period when the power is consumed, the server contained in the power transmission/distribution network-control device 130 may control the first switch 111 included in the first power source control device 110 such that the first storage battery 100 is connected to the first linkage section 113, and may control the second switch 121 included in the second power source control device 120 such that the second storage battery 102 is connected to the second linkage section 123.

### 2-7. Example of History of Position Information of Second Storage Battery

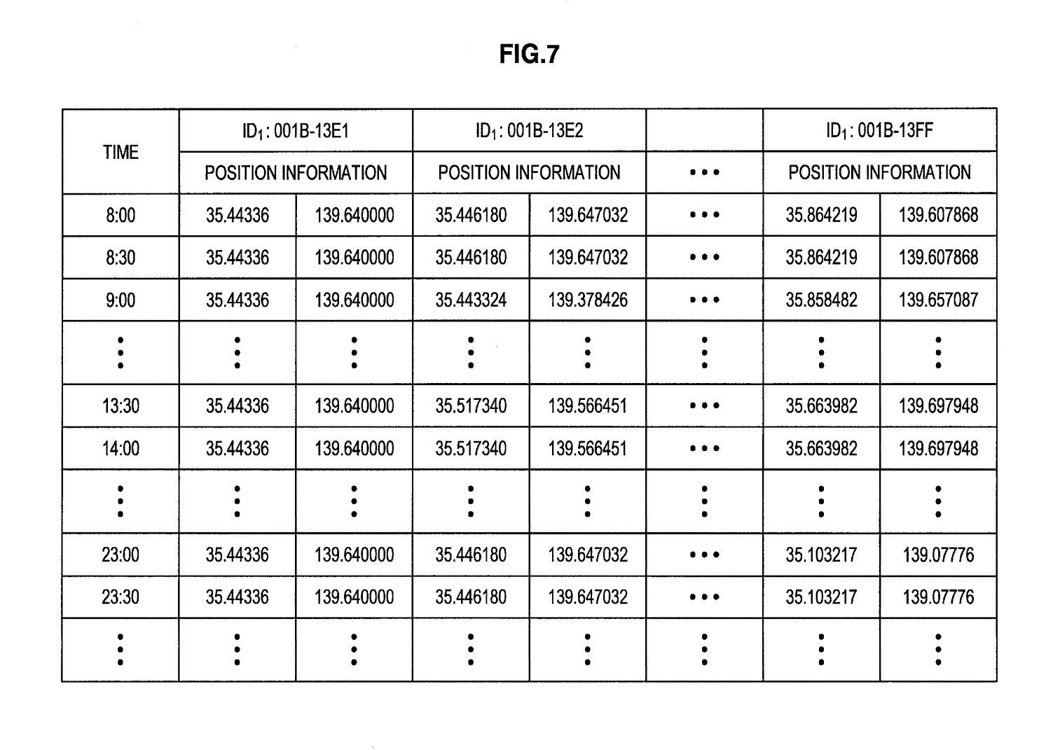

FIG. 7 is an example of histories of pieces of position information of respective second storage batteries 102 which are held by the server contained in the power transmission/distribution network-control device 130 included in the power transmission/distribution network system 10 according to the embodiment of the present disclosure. Here, the number of the second storage batteries 102 is two or more, but the number of the second storage batteries 102 is not particularly limited, and may be one, or two or more. Each piece of position information is classified based on the allocated specific first ID 105 for each second storage battery 102 that is added to the position information, and is stored in the form of latitude and longitude at regular time intervals.

### 2-8. Example of Average of Travel Distance

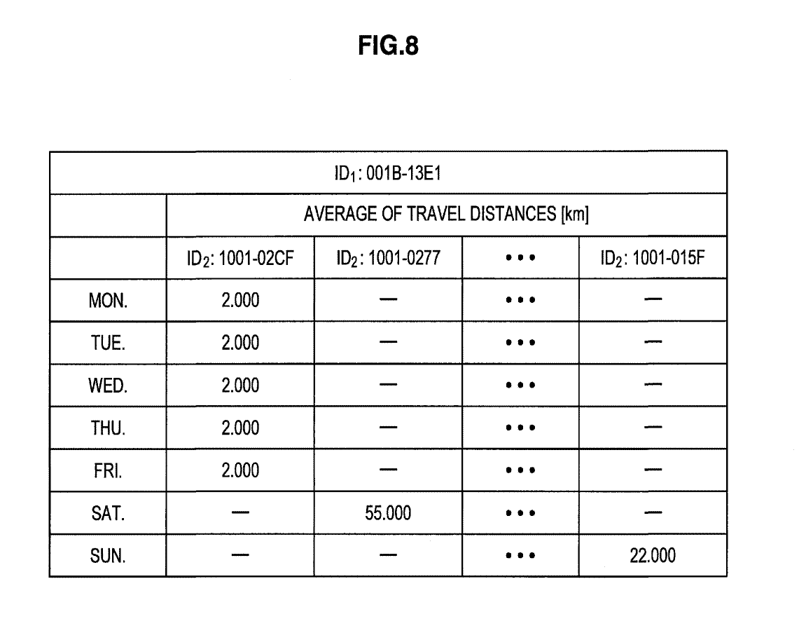

Further, the server contained in the power transmission/distribution network-control device 130 calculates an average of travel distances using the history of position information, and creates data shown in FIG. 8, as an example. FIG. 8 is a table showing an example of an average of travel distances calculated by the server contained in the power transmission/distribution network-control device 130 included in the power transmission/distribution network system 10 according to the embodiment of the present disclosure. The server contained in the power transmission/distribution network-control device 130 calculates, for each second power source control device 120 which has a history of connection, an average of distances travelled after the connection. In the server contained in the power transmission/distribution network-control device 130, there may be stored data in the form of an average of expected travel distances for each specific second ID 106 corresponding to the second power source control device 120, for each day of the week, for example.

The server contained in the power transmission/distribution network-control device 130 has a function of holding a history of position information of the second storage battery 102. Further, the server contained in the power transmission/distribution network-control device 130 has a function of estimating a travel distance after current time based on the history information, and has a function of calculating an amount of power necessary for the second storage battery 102 to travel based on the estimate of the travel distance. The server contained in the power transmission/distribution network-control device 130 has a function of performing control such that the second switch 121 included in the second power source control device 120 connected to the second storage battery 102 is connected to the second linkage section 123, when an amount of power calculated by subtracting the amount of power necessary for the second storage battery 102 to travel from a remaining charge level value of the second storage battery 102 exceeds an arbitrary threshold.

According to such a configuration, since the server contained in the power transmission/distribution network-control device 130 can estimate the travel distance using the acquired history of position information it becomes possible to calculate an amount of necessary power before the next charging opportunity. Accordingly, in combination with the information of remaining charge level of the storage battery, a part of remaining power in the storage battery may be effectively utilized at the power transmission/distribution system-side.

### 2-9. Control Example 1 of Connection Processing with Linkage Section

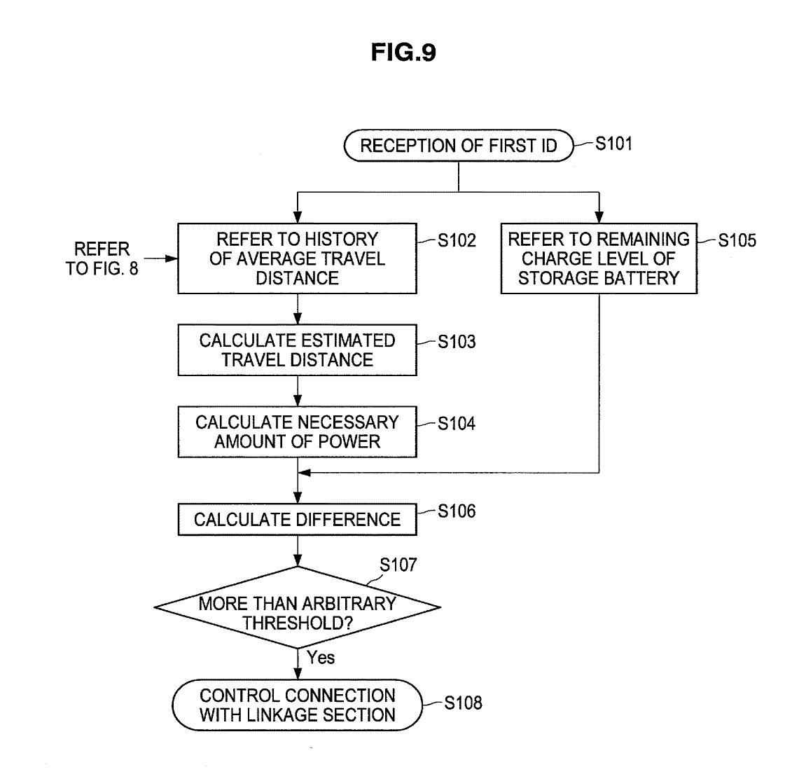

FIG. 9 is a diagram showing a flow of processing (control example 1 of connection processing with a linkage section) performed in the power transmission/distribution network system 10 according to the embodiment of the present disclosure. When the second power source control device 120 and the second storage battery 102 are connected to each other, the specific first ID 105 allocated to the second storage battery 102 is transmitted to the server contained in the power transmission/distribution network-control device 130 (Step S101). When receiving the specific first ID 105, the server contained in the power transmission/distribution network-control device 130 refers to the data on the average of travel distances managed for each second ID 106 shown in FIG. 8 (Step S 102), and extracts an average travel distance corresponding to the specific first ID 105. The server contained in the power transmission/distribution network-control device 130 calculates an estimated travel distance using the average travel distance (Step S103), and calculates an amount of power necessary for travelling the estimated travel distance (Step S104).

Next, the server contained in the power transmission/distribution network-control device 130 uses the specific first ID 105 allocated to the second storage battery 102 and the specific second ID 106 allocated to the second power source control device 120 as arguments, refers to FIG. 3, and extracts a remaining charge level of the second storage battery 102 (Step S105). The server contained in the power transmission/distribution network-control device 130 calculates a difference by subtracting the amount of power necessary for travelling the estimated travel distance from the remaining charge level (Step S 106), and determines whether or not the difference exceeds an arbitrary threshold (Step S107). When the difference exceeds the arbitrary threshold as a result of the determination, the server contained in the power transmission/distribution network-control device 130 controls the second switch 121 included in the second power source control device 120 such that the second storage battery 102 is connected to the second linkage section 123 (Step S108). In this way, the power stored in the second storage battery 102 becomes usable at the power transmission/distribution system-side.

### 2-10. Control Example of Connection Processing with Linkage Section and Connection Processing with Charging Section

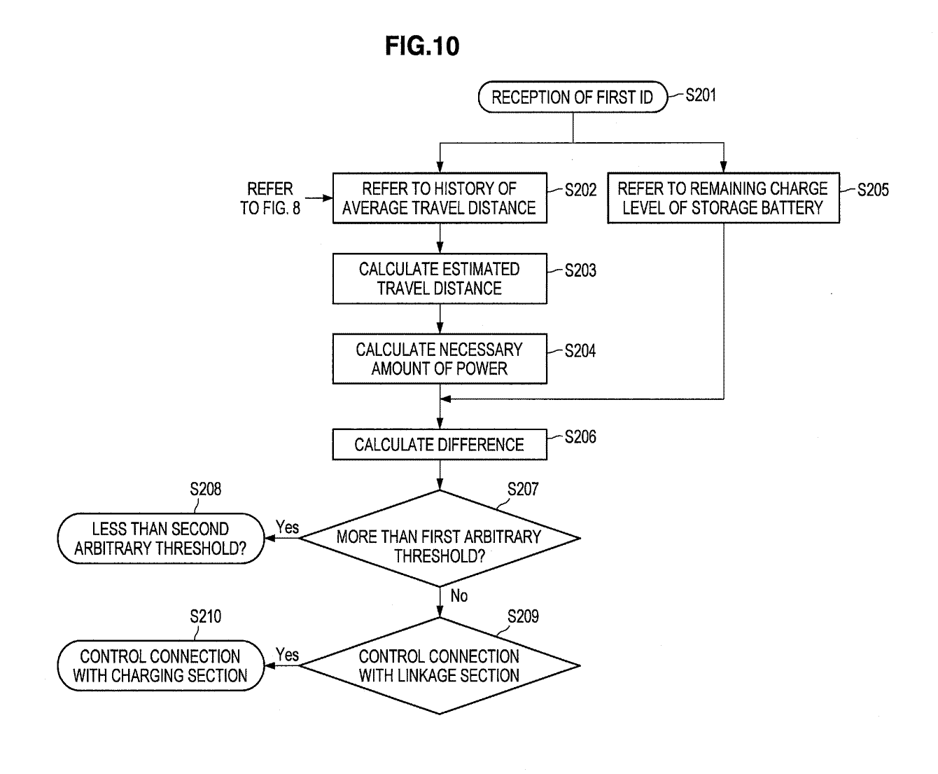

FIG. 10 is a diagram showing a flow of processing (control example of connection processing with the linkage section and connection processing with the charging section) performed in the power transmission/distribution network system 10 according to the embodiment of the present disclosure. The same description with the description of FIG. 9 is omitted, and the difference therebetween will be described. The server contained in the power transmission/distribution network-control device 130 calculates a difference by subtracting the amount of power necessary for travelling the estimated travel distance from the remaining charge level (Step S206), and determines whether or not the difference exceeds a first arbitrary threshold (Step S207). When the difference exceeds the first arbitrary threshold as a result of the determination, the server contained in the power transmission/distribution network-control device 130 controls the second switch 121 included in the second power source control device 120 such that the second storage battery 102 is connected to the second linkage section 123 (Step S208). In this way, the power stored in the second storage battery 102 becomes usable at the power transmission/distribution system-side.

On the other hand, when the difference is equal to or less than the first arbitrary threshold as a result of the determination, the server contained in the power transmission/distribution network-control device 130 subsequently determines whether or not the difference is less than a second arbitrary threshold (Step S209). When the difference is less than the second arbitrary threshold as a result of the determination, the server contained in the power transmission/distribution network-control device 130 controls the second switch 121 included in the second power source control device 120 such that the second storage battery 102 is connected to the second charging section 122 (Step S210). In this way, the second storage battery 102 receives power from the power transmission/distribution system-side, and the second storage battery 102 is charged. Note that it goes without saying that the first arbitrary threshold and the second arbitrary threshold can be set to a same value.

In this way, the server contained in the power transmission/distribution network-control device 130 has a function of controlling the second switch 121 such that the second storage battery 102 is connected to the second linkage section 123 included in the second power source control device 120, when an amount of power calculated by subtracting the amount of power necessary for the second storage battery 102 to travel from a remaining charge level value of the second storage battery 102 exceeds a first arbitrary threshold. Further, the server contained in the power transmission/distribution network-control device 130 has a function of controlling the second switch 121 such that the second storage battery 102 is connected to the second charging section 122 included in the second power source control device 120, when the amount of power calculated by subtracting the amount of power necessary for the second storage battery 102 to travel from the remaining charge level value of the second storage battery 102 is less than a second arbitrary threshold.

According to such a configuration, it becomes possible to effectively utilize the storage battery mounted on an electric vehicle or the like at the power transmission/distribution system-side, and it also becomes possible to efficiently realize an original use of the electric vehicle, for example, imparting the electric vehicle with the flexibility of getting charged depending on the situation.

### 2-11. Control Example 2 of Connection Processing with Linkage Section

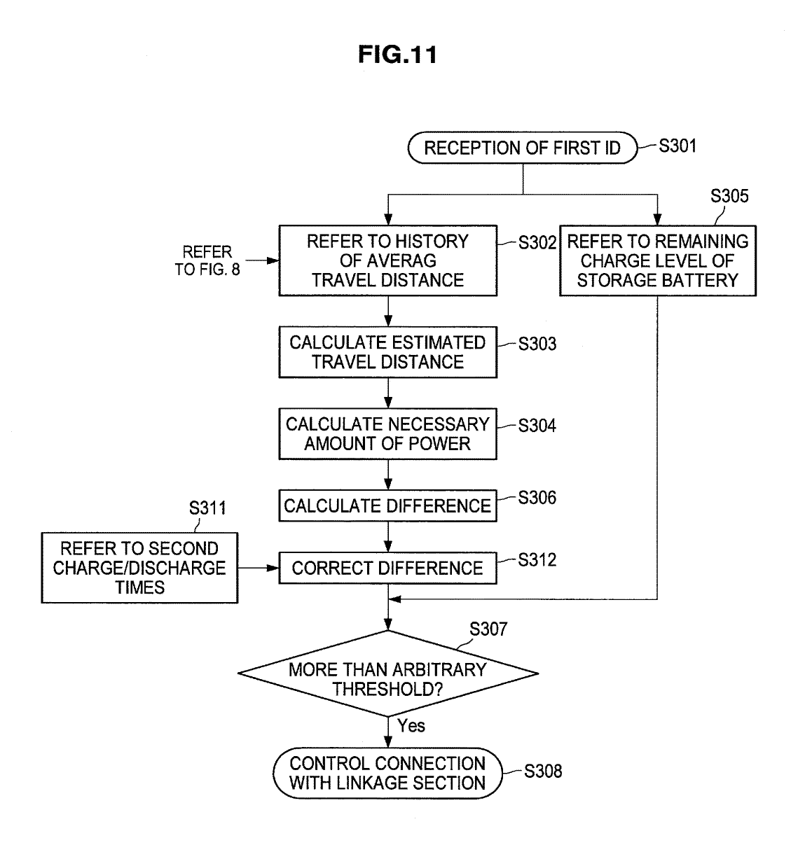

FIG. 11 is a diagram showing a flow of processing (control example 2 of connection processing with the linkage section) performed in the power transmission/distribution network system 10 according to the embodiment of the present disclosure. The same description with the description of FIG. 9 is omitted, and the difference therebetween will be described. The server contained in the power transmission/distribution network-control device 130 calculates a difference between amounts of power by subtracting the amount of power necessary for travelling the estimated travel distance from the remaining charge level (Step S306). Next, the server contained in the power transmission/distribution network-control device 130 refers to the second charge/discharge times transmitted from the second power source control device 120 (Step S311), and in the case where the second charge/discharge times is large, the server contained in the power transmission/distribution network-control device 130 performs correction such that the difference between amounts of power becomes small (Step S312). In this way, it becomes possible to respond to the deterioration phenomenon that the discharge duration becomes shorter than the discharge duration of a new battery, caused by the deterioration of the second storage battery 102.

In this way, the server contained in the power transmission/distribution network-control device 130 is capable of performing correction in accordance with the charge/discharge times of the second storage battery 102 with respect to the amount of power calculated by subtracting each amount of power necessary for the second storage battery 102 to travel from a remaining charge level value of the second storage battery 102.

According to such a configuration, the deterioration of discharge characteristics can be estimated using the charge/discharge times of the storage battery, and it becomes possible to estimate more accurately the amount of power of the storage battery that can be used at the power transmission/distribution system-side.

### 2-12. Control Example 3 of Connection Processing with Linkage Section

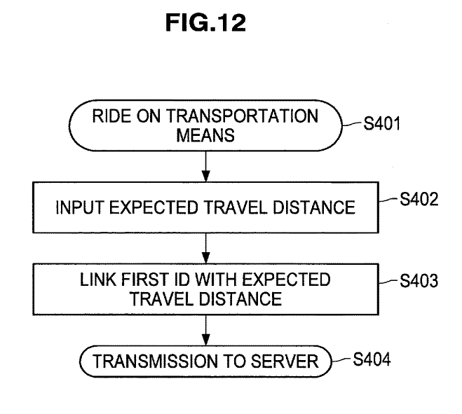

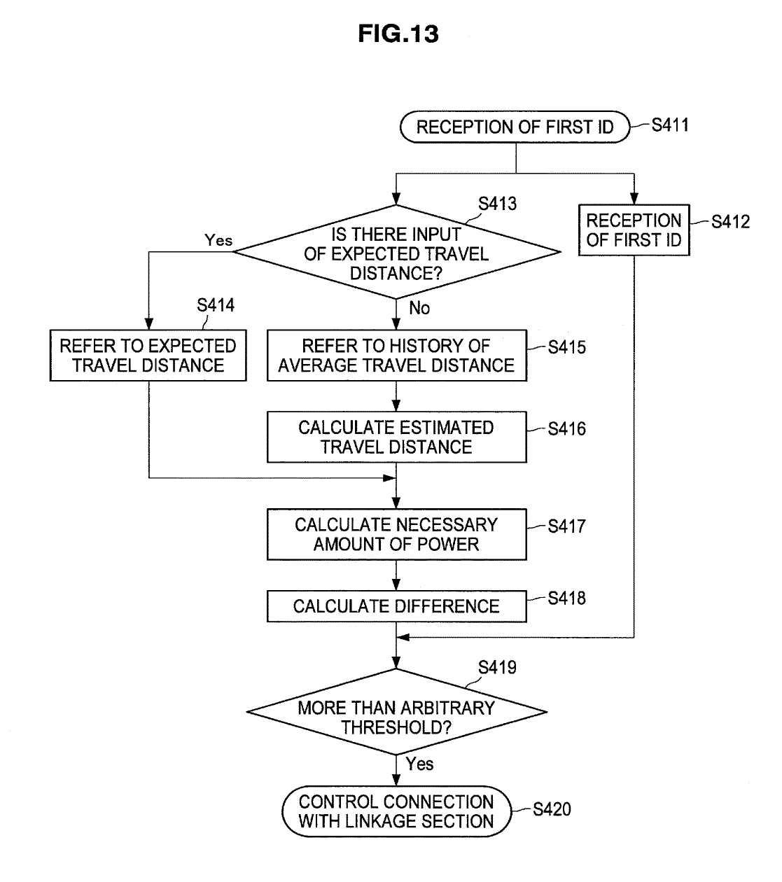

FIG. 12 and FIG. 13 are each a diagram showing a flow of processing (control example 3 of connection processing with the linkage section) performed in the power transmission/distribution network system 10 according to the embodiment of the present disclosure. For example, when a user rides on the transportation means 101 such as an electric vehicle at the beginning of one day (Step S401), in the case where the user has a clear grasp of a travel distance of that day, the user inputs an expected travel distance using an input device which is provided beforehand to the transportation means 101 such as the electric vehicle (Step S402). The second power source control device 120 links the input expected travel distance with a specific first ID 105 allocated to the second storage battery 102 mounted on the transportation means 101 such as the electric vehicle (Step S403), and transmits the specific first ID 105 linked with the expected travel distance to the server contained in the power transmission/distribution network-control device 130 (Step S404).

When the server contained in the power transmission/distribution network-control device 130 receives the specific first ID 105 (Step S411), the server contained in the power transmission/distribution network-control device 130 determines whether or not there is an input of the expected travel distance (Step S413), and in the case where there is an input of the expected travel distance, refers to the expected travel distance (Step S414), and in the case where there is no input of the expected travel distance, refers to a history of average travel distances shown in FIG. 8 (Step S415), and calculates an estimated travel distance (Step S416). The server contained in the power transmission/distribution network-control device 130 uses information of the travel distance obtained by the above processing, and based on the similar processing as the processing of FIG. 9, controls the second switch 121 included in the second power source control device 120 (Step S420). Note that it goes without saying that the input of the expected travel distance may be an input of a distance per day or a distance to be travelled during an arbitrary time period.

Further, the processing of inputting the travel distance as shown in FIG. 12 (Step S402) may be performed in conjunction with the car navigation device. Specifically, as a destination target point which the user request to show a route to, there is input information such as an address, a name, or a name of a station, the car navigation device calculates route information based on the information and also calculates a travel distance and a necessary time from the calculated route information. The travel distance and the necessary time calculated by the car navigation device may be used as the expected travel distance by the server contained in the power transmission/distribution network-control device 130.

In this way, the second storage battery 102-mounted transportation means 101 such as an electric vehicle is also capable of setting the expected travel distance after current time. The transportation means 101 such as an electric vehicle is also capable of having a function of transmitting the expected travel distance being linked with the specific first ID 105 allocated to the second storage battery 102 to the server contained in the power transmission/distribution network-control device 130 using communication via wire or radio. The server contained in the power transmission/distribution network-control device 130 is capable of prioritizing, to the predicted value of the travel distance after current time calculated at the server-side, the expected travel distance after current time transmitted from the second storage battery 102-mounted transportation means 101 such as the electric vehicle.

According to such a configuration, since the user of the transportation means 101 such as the electric vehicle notifies a manager of the power transmission/distribution system of more accurate expected travel distance, it becomes possible for the manager of the power transmission/distribution system to more accurately estimate an available amount of power in the storage battery.

### 2-13. Control Example 4 of Connection Processing with Linkage Section

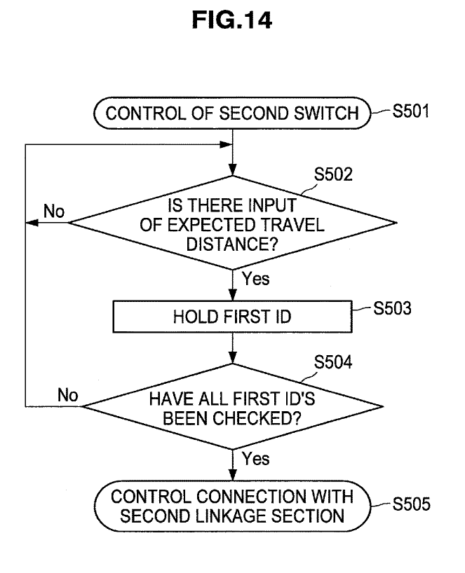

FIG. 14 is a diagram showing a flow of processing (control example 4 of connection processing with the linkage section) performed in the power transmission/distribution network system 10 according to the embodiment of the present disclosure. When determining the control of the second switch 121 included in the second power source control device 120 (Step S501), first, the server contained in the power transmission/distribution network-control device 130 classifies all the specific first ID's 105 managed by the server contained in the power transmission/distribution network-control device 130 into a group in which the setting of the expected travel distance is performed and a group in which the setting of the expected travel distance is not performed. FIG. 14 shows an example of the classification processing. The server contained in the power transmission/distribution network-control device 130 refers to the first ID 105 one by one, determines whether or not the setting of the expected travel distance is performed (Step S502), and, in the case where the first ID 105 being referred to is the one to which the setting of the expected travel distance is performed, stores the first ID 105 into a storage area of the group in which the setting of the expected travel distance is performed (Step S503).

When the server contained in the power transmission/distribution network-control device 130 finishes referring to all the first ID's 105 (“Yes” in Step S504), the server contained in the power transmission/distribution network-control device 130 can classify the first ID's 105 into the group in which the setting of the expected travel distance is performed and the group in which the setting of the expected travel distance is not performed. Note that it goes without saying that the processing of classifying the first ID's 105 into the group in which the setting of the expected travel distance is performed and the group in which the setting of the expected travel distance is not performed is not limited to such an example. Then, the server contained in the power transmission/distribution network-control device 130 controls the second switch 121 included in the second power source control device 120 connected to the second storage battery 102, such that the second storage battery 102 corresponding to the first ID 105 included in the group in which the setting of the expected travel distance is performed is connected to the second linkage section 123 (Step S505).

In this way, the server contained in the power transmission/distribution network-control device 130 is capable of having a function of classifying all the specific first ID's 105 managed by the power transmission/distribution network-control device 130 into the group in which the setting of the expected travel distance is performed and the group in which the setting of the expected travel distance is not performed. The server contained in the power transmission/distribution network-control device 130 is capable of controlling the second switch 121, which is included in the second power source control device 120 connected to the second storage battery 102 corresponding to the first ID 105 included in the group in which the setting of the expected travel distance is performed, to be preferentially connected to the second linkage section 123.

According to such a configuration, by preferentially utilizing the power of the storage battery in which an accurate travel distance is set, the power transmission/distribution system-side becomes capable of more effectively utilizing the power of the storage battery.

Further, as described above, when an expected travel distance after current time is to be set by the server contained in the power transmission/distribution network-control device 130, it is also possible to set, as the expected travel distance, route information calculated by a car navigation device using an address or a name of a destination target point, a name of a station, or the like that is input to the car navigation device, and a distance of the road calculated using the route information.

### 2-14. Purchase Unit Price-Determination Processing

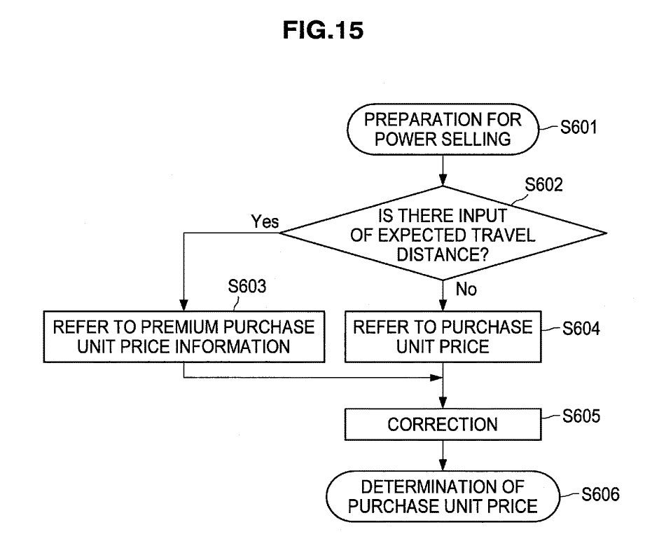

FIG. 15 is a diagram showing a flow of processing (purchase unit price-determination processing) performed in the power transmission/distribution network system 10 according to the embodiment of the present disclosure. The connection establishment between the second storage battery 102 and the second linkage section 123 means that power stored in the second storage battery 102 becomes available at the power transmission/distribution system-side. When a user permits the use of the power in a form that the power transmission/distribution system-side purchases the power, it can be considered that a user who sets an expected travel distance provides, compared to a user who does not set an expected travel distance, the power transmission/distribution system-side with more accurate estimate of travel distance. It is assumed that the power transmission/distribution system-side can estimate the travel distance in a smaller margin, and more power can be used out of the remaining charge level of the second storage battery 102. Consequently, it is considered to match market mechanisms that the power transmission/distribution system purchases the power at a higher price as remuneration for the offer of the highly accurate estimate.

At the power transmission/distribution system-side, a preparation for electric power selling is started (Step S601), and the server contained in the power transmission/distribution network-control device 130 determines whether or not the setting of a travel distance is performed (Step S602). When the setting of the travel distance is performed, the server contained in the power transmission/distribution network-control device 130 refers to premium purchase unit price information (Step S603), and performs correction based on the additional part (Step S605). When the setting of the travel distance is not performed, the server contained in the power transmission/distribution network-control device 130 refers to purchase unit price information (Step S604), and, when there is premium purchase unit price information, performs correction based on the additional part (Step S605). In this manner, the server contained in the power transmission/distribution network-control device 130 determines the purchase unit price (Step S606).

In this way, the server contained in the power transmission/distribution network-control device 130 is capable of executing the charging of a fee such that the purchase price of the power is raised, with respect to an owner of the second storage battery 102-mounted transportation means 101 such as the electric vehicle which transmits information of an expected travel distance after current time.

According to such a configuration, for the user who sets more accurate travel distance, the electric power selling price is raised, and hence, more active setting of travel distance is promoted. As a result, it becomes possible to effectively utilize the power of the storage battery, and the user can also receive the advantage that electricity usage charge is equivalently reduced.

### 2-15. Control Example 1 of Connection Processing with Charging Section

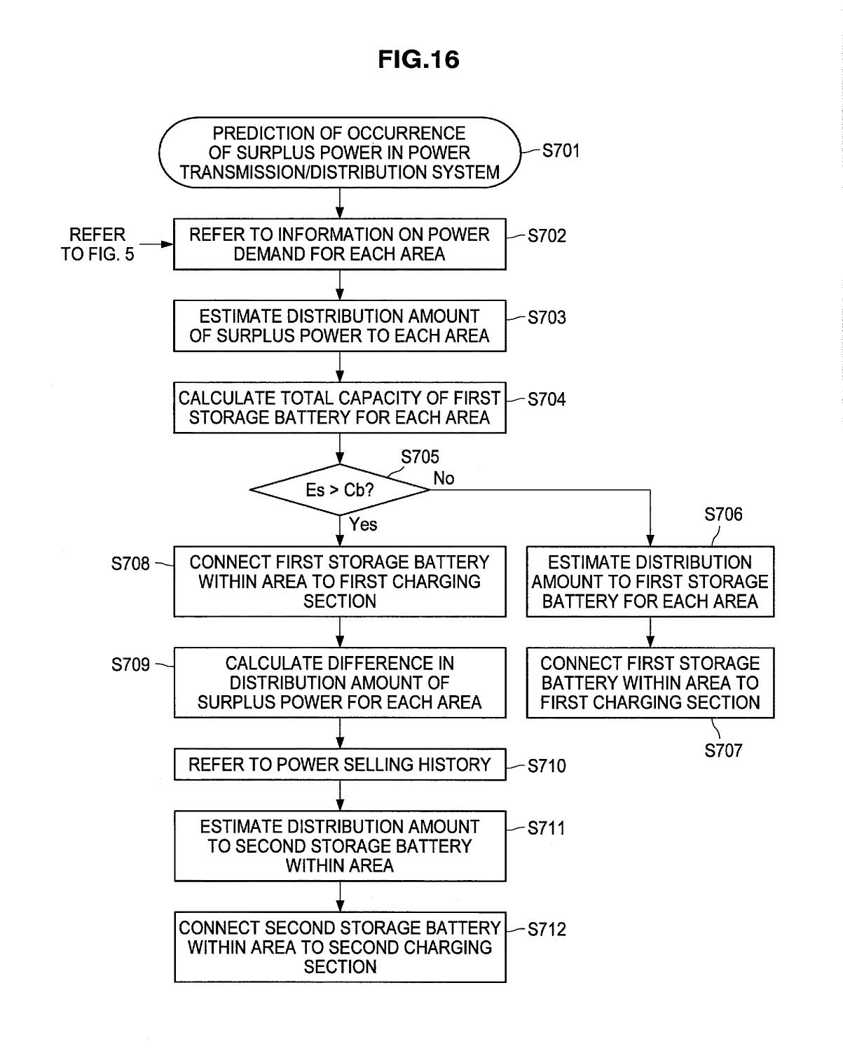

FIG. 16 is a diagram showing a flow of processing (control example 1 of connection processing with the charging section) performed in the power transmission/distribution network system 10 according to the embodiment of the present disclosure. When there is predicted the occurrence of surplus power in an amount of power generated by a power plant included in a power transmission/distribution system during nighttime, for example (Step S701), the server contained in the power transmission/distribution network-control device 130 refers to information on power demand for each area (Step S702). The server contained in the power transmission/distribution network-control device 130 estimates an amount of power to be consumed the next day from the information on power demand for each area, and, in accordance with the estimated value for each area, estimates a distribution amount of the surplus power for each area (Step S703).

Next, the server contained in the power transmission/distribution network-control device 130 calculates a sum total of maximum capacity of the first storage batteries 100 for each area (Step S704), and determines whether or not a distribution amount (Es) of surplus power for each area is larger than a sum total (Cb) of maximum capacity of the first storage batteries 100 for each area (Step S705). Here, in the case where the distribution amount (Es) of surplus power for each area is larger than the sum total (Cb) of maximum capacity of the first storage batteries 100, the server contained in the power transmission/distribution network-control device 130 controls the first switch 111 such that all the first storage batteries 100 within the area are connected to the first charging section 112 included in the first power source control device 110 (Step S708).

Next, the server contained in the power transmission/distribution network-control device 130 calculates a difference in the surplus power after the first storage batteries 100 are connected to the first charging section 112 included in the first power source control device 110 (Step S709). In addition, the server contained in the power transmission/distribution network-control device 130 refers to a specific first ID 105 allocated to the second storage battery 102 and an electric power selling history in the area (Step S710), and calculates a distribution amount to the second storage battery 102 within an area based on the difference of the surplus power for each area (Step S711). Here, since the second storage battery 102 has mobility, there is a case where an area in which charging is performed is different from an area in which electric power selling is performed. In such a case, a part of the distribution amount to the second storage battery 102 within an area which is estimated based on the difference of the surplus power for each area is traded between areas. Then, the server contained in the power transmission/distribution network-control device 130 controls the second switch 121 such that, based on the final distribution amount of the second storage battery 102 within the area, the second storage battery 102 is connected to the second charging section 122 included in the second power source control device 120 (Step S712).

On the other hand, in the case where the distribution amount (Es) of surplus power for each area is equal to or less than the sum total (Cb) of maximum capacity of the first storage batteries 100, the server contained in the power transmission/distribution network-control device 130 estimates the distribution amount to the first storage batteries 100 based on the surplus power for each area (Step S706), and, in accordance with the estimated value, controls the first switch 111 such that the first storage battery 100 is connected to the first charging section 112 included in the first power source control device 110 (Step S707).

In this way, the server contained in the power transmission/distribution network-control device 130 has a function of detecting surplus power generated in a power transmission/distribution network. Further, the server contained in the power transmission/distribution network-control device 130 has a function of determining the distribution amount of the surplus power for each geographically divided area based on the information on power demand for each geographically divided area. In addition, the server contained in the power transmission/distribution network-control device 130 has a function of calculating the sum total of charging capacity of the first storage batteries 100 for each geographically divided area.

The server contained in the power transmission/distribution network-control device 130 controls, in the case where the distribution amount of surplus power for each geographically divided area is larger than the sum total of charging capacity of the first storage batteries 100 for each geographically divided area, all the first storage batteries 100 within the geographically divided area to be connected to the first charging section 112 included in the first power source control device 110. In addition, the server contained in the power transmission/distribution network-control device 130 has a function of calculating a redistribution amount of surplus power for each area after the connection establishment between the first storage batteries 100 and the first charging section 112 included in the first power source control device 110.

Further, the server contained in the power transmission/distribution network-control device 130 has a function of referring to an electric power selling history of the second storage battery 102 and has a function of trading a part of the redistribution amount of surplus power for each area between areas based on the electric power selling history. In addition, the server contained in the power transmission/distribution network-control device 130 has a function of estimating a distribution amount to the second storage batteries 102 within each area based on the redistribution amount of surplus power for each area, and, in accordance with the estimated amount of power, performs control in a manner that the second storage batteries 102 within the geographically divided area are connected to the second charging section 122 included in the second power source control device 120.

The server contained in the power transmission/distribution network-control device 130 has a function of, in the case where the distribution amount of surplus power for each geographically divided area is smaller than the sum total of charging capacity of the first storage batteries 100 for each geographically divided area, estimating a distribution amount to the first storage batteries 100 within each area based on the distribution amount of surplus power for each area. The server contained in the power transmission/distribution network-control device 130 performs control, in accordance with the estimated amount of power, in a manner that the first storage batteries 100 within the geographically divided area is connected to the first charging section 112.

According to such a configuration, it becomes possible to efficiently store nighttime surplus power with taking daytime power demand into consideration.

### 2-16. Control Example 2 of Connection Processing with Charging Section

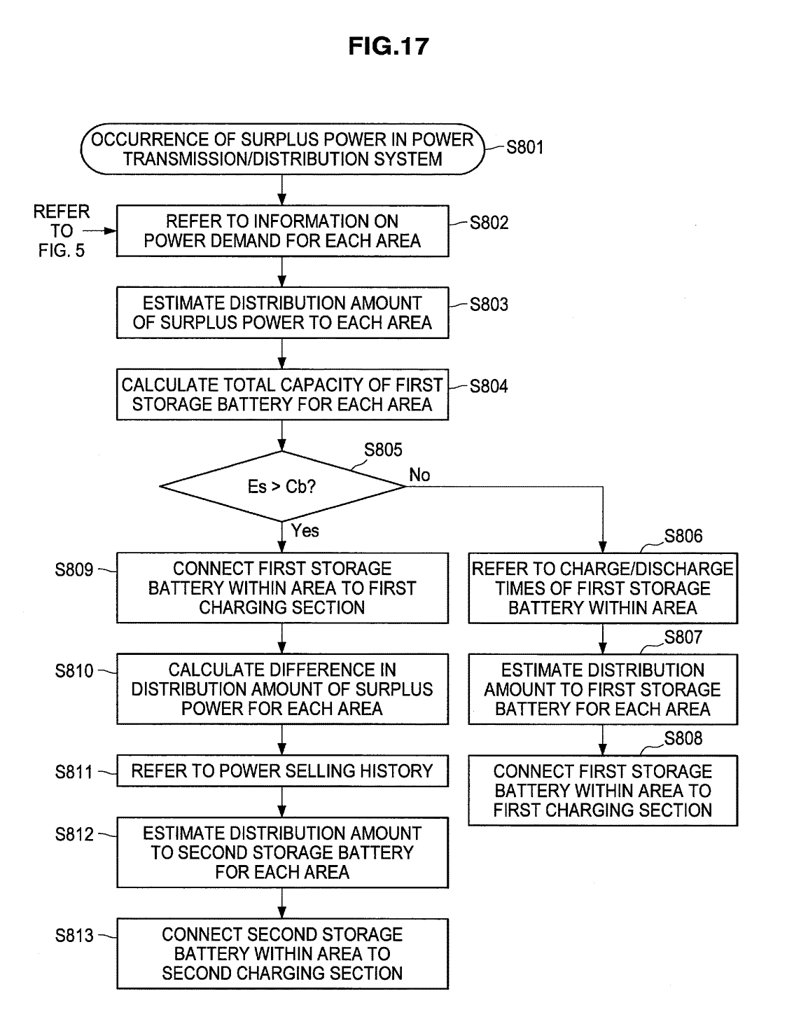

FIG. 17 is a diagram showing a flow of processing (control example 2 of connection processing with the charging section) performed in the power transmission/distribution network system 10 according to the embodiment of the present disclosure. The same description with the description of FIG. 16 is omitted, and the difference therebetween will be described. The server contained in the power transmission/distribution network-control device 130 determines whether or not a distribution amount (Es) of surplus power for each area is larger than a sum total (Cb) of maximum capacity of the first storage batteries 100 for each area (Step S805), and in the case where the distribution amount (Es) of surplus power for each area is equal to or less than the sum total (Cb) of maximum capacity of the first storage batteries 100, the server contained in the power transmission/distribution network-control device 130 refers to charge/discharge times of the first storage batteries 100 within the area (Step S806), and estimates the distribution amount to the first storage batteries 100 based on the surplus power for each area (Step S807). The server contained in the power transmission/distribution network-control device 130 controls, based on the estimated value, the first switch 111 included in the first power source control device 110 such that a first storage battery 100 the charge/discharge times of which is small is preferentially charged (Step S808).

In this way, the server contained in the power transmission/distribution network-control device 130 is capable of performing, before performing the processing of estimating the distribution amount to the first storage batteries 100 within each area based on the distribution amount of surplus power for each area, the processing of referring to the charge/discharge times of the first storage batteries 100 within the area. The server contained in the power transmission/distribution network-control device 130 is capable of performing control in a manner that a first storage battery 100 the charge/discharge times of which is small is preferentially connected to the first charging section 112 included in the first power source control device 110.

According to such a configuration, deterioration of storage batteries used for the charging of surplus power can be equalized therebetween, and the failure frequency can be reduced.

### 2-17. Thermal Power Generation Capacity-Determination Processing

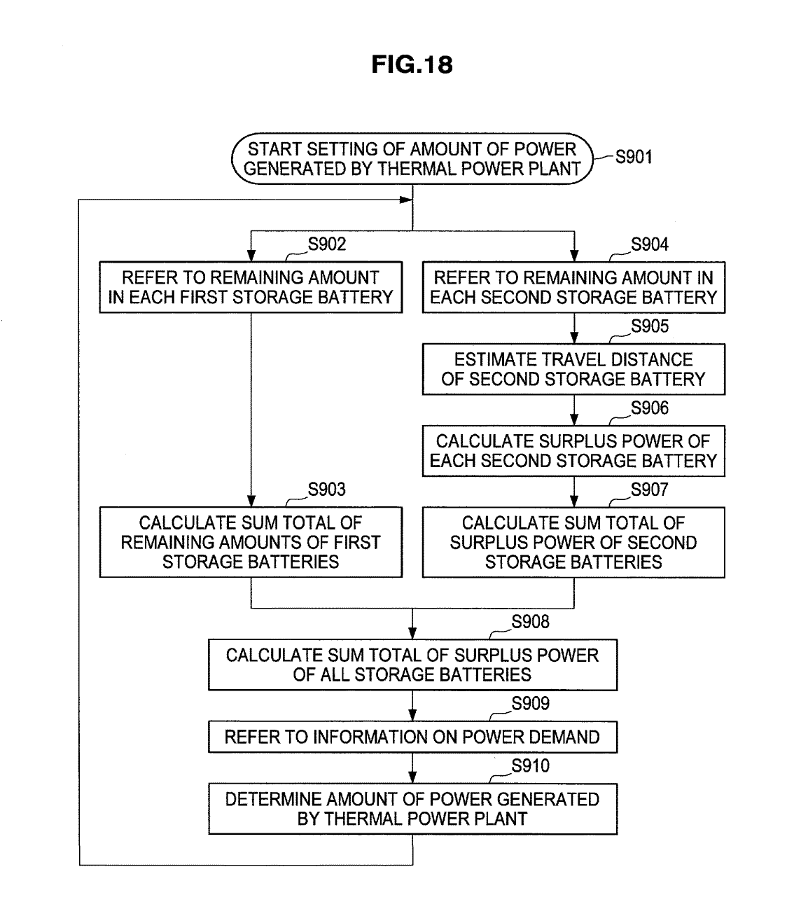

FIG. 18 is a diagram showing a flow of processing (thermal power generation capacity-determination processing) performed in the power transmission/distribution network system 10 according to the embodiment of the present disclosure. The increase in power demand during daytime is currently supplemented by basically increasing the amount of power generated by a thermal power plant. When the setting of the amount of power generated by the thermal power plant is started (Step S901), the server contained in the power transmission/distribution network-control device 130 refers to a remaining amount in the first storage battery 100 (Step S902), and calculates a sum total of remaining amounts of the first storage batteries 100 (Step S903).

Further, the server contained in the power transmission/distribution network-control device 130 refers to a remaining amount in the second storage battery 102 (Step S904), estimates a travel distance of the second storage battery 102-mounted transportation means 101 such as an electric vehicle (Step S905), calculates surplus power of the second storage battery 102 (Step S906), and calculates the sum total thereof (Step S907). In this manner, it becomes possible to calculate a sum total of surplus power of the first storage battery 100 and the second storage battery 102 (Step S908).

In addition, the server contained in the power transmission/distribution network-control device 130 refers to information on power demand (Step S909), and sets, as an amount of power to be generated in the thermal power plant, a power demand amount which exceeds the sum total of surplus power of the first storage battery 100 and the second storage battery 102 and the sum total of power generated from a power source other than the thermal power generation (Step S910). Here, it goes without saying that examples of the power generated from the power source other than the thermal power generation include power supplied by hydraulic power generation, nuclear power generation, wind power generation, geothermal power generation, and solar power generation.

In this manner, the server contained in the power transmission/distribution network-control device 130 is capable of adjusting the amount of power generated by the thermal power plant in accordance with: the sum total of the amount of power calculated based on the remaining charge level value of the first storage battery 100; and the sum total of amount of power calculated by subtracting, from the remaining charge level value of the second storage battery 102, an amount of power necessary for the second storage battery 102 to travel calculated based on the predicted value of a travel distance calculated by using a history of position information or the set value of an expected travel distance.

According to such a configuration, since more power can be stored during nighttime using a power generation method with reduced CO₂ emissions and the stored power can be utilized during the daytime period when the power demand is high, the ratio of the power supplied by thermal power generation which emits a large amount of CO₂ can be reduced, and there can be expected even greater CO₂ emission-reduction effect.

### 3. MODIFIED EXAMPLE

It should be understood by those skilled in the art that various modifications, combinations, sub-combinations and alterations may occur depending on design requirements and other factors insofar as they are within the scope of the appended claims or the equivalents thereof.

### 4. EFFECTS

As described above, according to the embodiment of the present disclosure, the fixed storage battery and the storage battery mounted on an electric vehicle, which is considered to be widespread in the days to come, or the like can be charged with the nighttime surplus power, and the power stored in those storage batteries is utilized during the daytime period when the power demand is high, which enables the operation in which the energy supplied by the nuclear power generation, which is used as a base in “Optimal Combination of Power Sources”, is increased, and there can be expected CO₂ emission-reduction effect.

The present disclosure contains subject matter related to that disclosed in Japanese Priority Patent Application JP 2010-192251 filed in the Japan Patent Office on Aug. 30, 2010, the entire content of which is hereby incorporated by reference.

1. An information processing apparatus comprising:
a communication section configured to receive a predetermined state quantity of a first storage battery from a first power source control device connected to the first storage battery; and
a control section configured to control a first switch, the first switch being for establishing a connection, based at least in part on the predetermined state quantity of the first storage battery, between a first charging section which charges the first storage battery or a first linkage section which transmits power accumulated in the first storage battery to a distribution system, and the first storage battery.

2. The information processing apparatus according to claim 1,
wherein the communication section further receives a predetermined state quantity of a second storage battery mounted on first transportation means from a second power source control device connected to the second storage battery, and
wherein the control section controls a second switch, the second switch being for establishing a connection, based at least in part on the predetermined state quantity of the second storage battery, between a second charging section which charges the second storage battery or a second linkage section which transmits power accumulated in the second storage battery to a distribution system, and the second storage battery.

3. The information processing apparatus according to claim 2, further comprising:
a data storage section in a case where there are one or a plurality of the first storage batteries and one or a plurality of second storage batteries, the data storage section being for storing information on power demand for each of geographically divided areas, and also stores charging capacity of the one or plurality of first storage batteries for each of the areas and charging capacity of the one or plurality of second storage batteries for each of the areas,
wherein the control section calculates a sum total of charging capacity of the one or plurality of first storage batteries and the charging capacity of the one or plurality of second storage batteries for each of the areas, and controls the first switch and the second switch based at least in part on the calculated sum total for each of the areas and the information on power demand stored in the data storage section.

4. The information processing apparatus according to claim 2,
wherein the communication section receives, as the predetermined state quantity of the second storage battery, a remaining charge level value representing an amount of power stored in the second storage battery, and further receives position information of the second storage battery from the first transportation means as history information, and
wherein the control section calculates an estimated consumption amount representing an amount of power of the second storage battery that is estimated to be consumed by driving the first transportation means based at least in part on the history information received by the communication section, and, when an amount of power obtained by subtracting the estimated consumption amount from the remaining charge level value received by the communication section exceeds a first threshold, the control section controls the second switch such that the second linkage section and the second storage battery are connected to each other.

5. The information processing apparatus according to claim 4,
wherein, when the amount of power obtained by subtracting the estimated consumption amount from the remaining charge level value received by the communication section is less than a second threshold, the control section controls the second switch such that the second charging section and the second storage battery are connected to each other.

6. The information processing apparatus according to claim 4,
wherein the communication section further receives, in addition to the remaining charge level value, charge/discharge times of the second storage battery as the predetermined state quantity of the second storage battery, and
wherein the control section performs correction in accordance with the charge/discharge times of the second storage battery, with respect to the amount of power obtained by subtracting the estimated consumption amount from the remaining charge level value received by the communication section, and compares the corrected amount of power with the threshold.

7. The information processing apparatus according to claim 4,
wherein, when the communication section further receives an expected travel distance from the first transportation means, the control section uses an amount of power corresponding to the expected travel distance received by the communication section instead of the estimated consumption amount.

8. The information processing apparatus according to claim 4,
wherein, when an expected travel distance is not received from the first transportation means and an expected travel distance is received from the second transportation means by the communication section, the control section controls a switch such that a second storage battery mounted on the second transportation means is connected to a second linkage section which transmits power accumulated in the second storage battery to a distribution system, instead of controlling the second switch such that the second storage battery mounted on the first transportation means and the second linkage section are connected to each other.

9. The information processing apparatus according to claim 8,
wherein the control section calculates a price of power accumulated in the second storage battery mounted on the second transportation means to be higher than a price of power accumulated in the second storage battery mounted on the first transportation means.

10. The information processing apparatus according to claim 2, further comprising:
a data storage section in a case where there are one or a plurality of first storage batteries and one or a plurality of second storage batteries, the data storage section being for storing information on power demand for each of geographically divided areas, and also stores charging capacity of the one or plurality of first storage batteries for each of the areas and charging capacity of the one or plurality of second storage batteries for each of the areas,
wherein the control section determines a distribution amount of surplus power generated in the distribution system for each of the areas based at least in part on the information on power demand stored in the data storage section, calculates a sum total of the charging capacity of the one or plurality of first storage batteries for each of the areas, controls, as for an area in which the distribution amount is larger than the sum total, the first switch such that the first charging section and the first storage battery are connected to each other, and, controls, as for an area in which the distribution amount is smaller than the sum total, the first switch such that the first charging section and the first storage battery are connected to each other, based at least in part on geographical distribution of the information on power demand within the area stored in the data storage section.

11. The information processing apparatus according to claim 10,
wherein, as for an area in which the distribution amount is larger than the sum total, the control section controls the first switch such that the first charging section and the first storage battery are connected to each other and also calculates a difference between the sum total and the distribution amount for each of the areas as a redistribution value, and controls the second switch such that the second charging section and the second storage battery of the area are connected to each other based at least in part on the redistribution value.

12. The information processing apparatus according to claim 10, further comprising:
a data storage section configured to store an electric power selling history representing a history on electric power selling between areas,
wherein the control section calculates, as for a first area, which is an area that the distribution amount is larger than the sum total, a difference between the sum total and the distribution amount as a redistribution value, calculates a part or all of the redistribution value as a trade-distribution amount to be traded to a second area, which is different from the first area based at least in part on the electric power selling history stored in the data storage section, controls the second switch such that, based at least in part on a value obtained by subtracting the trade-distribution amount from the redistribution value, the second charging section and the second storage battery of the first area are connected to each other, and controls the second switch such that, based on the trade-distribution amount, the second charging section and the second storage battery of the second area are connected to each other.

13. The information processing apparatus according to claim 10,
wherein the communication section receives charge/discharge times of each of the one or plurality of first storage batteries as the predetermined state quantity of each of the one or plurality of first storage batteries, and
wherein the control section controls the first switch such that, as for an area the distribution amount of which is smaller than the sum total, the first storage battery having smaller charge/discharge times is preferentially connected to the first charging section.

14. The information processing apparatus according to claim 7,
wherein, in a case where there are one or a plurality of the first storage batteries and one or a plurality of the second storage batteries, the communication section receives a remaining charge level value of each of the one or plurality of first storage batteries as the predetermined state quantity of each of the one or plurality of first storage batteries, and also receives a remaining charge level value of each of the one or plurality of second storage batteries as the predetermined state quantity of each of the one or plurality of second storage batteries, and
wherein the control section determines an amount of power generation in a thermal power plant, based on a sum total obtained by adding up a value obtained by subtracting an amount of power corresponding to the estimated consumption amount or the expected travel distance from a sum total of the remaining charge level values of the respective one or plurality of second storage batteries, and a sum total of the remaining charge level values of the respective one or plurality of first storage batteries.

15. An information processing method comprising:
receiving a predetermined state quantity of a first storage battery from a first power source control device connected to the first storage battery; and
controlling a first switch, the first switch being for establishing a connection, based on the predetermined state quantity of the first storage battery, between a first charging section which charges the first storage battery or a first linkage section which transmits power accumulated in the first storage battery to a distribution system, and the first storage battery.

16. An information processing system comprising:
a first power source control device which is connected to a first storage battery and includes a communication section that transmits a predetermined state quantity of the first storage battery; and
an information processing apparatus which includes
a communication section configured to receive the predetermined state quantity of the first storage battery from the first power source control device, and
a control section configured to control a first switch, the first switch being for establishing a connection, based on the predetermined state quantity of the first storage battery, between a first charging section which charges the first storage battery or a first linkage section which transmits power accumulated in the first storage battery to a distribution system, and the first storage battery.

17. Transportation means which mounts a storage battery thereon, and transmits, as history information, position information of the storage battery to an information processing apparatus,
wherein the information processing apparatus calculates an estimated consumption amount representing an amount of power of the storage battery that is estimated to be consumed by driving the transportation means based on the history information, and, when an amount of power obtained by subtracting the estimated consumption amount from a remaining charge level value of the storage battery exceeds a first threshold, the information processing apparatus controls a switch such that a linkage section which transmits power accumulated in the storage battery to a distribution system is connected to the storage battery.
